(19) United States
(12) Patent Application Publication
(10) Pub. No.: US 2025/0335438 A1
(43) Pub. Date: Oct. 30, 2025

(54) INFORMATION RETRIEVAL THROUGH QUERY HISTORY INSIGHT

(71) Applicant: Snowflake Inc., Bozeman, MT (US)

(72) Inventors: Muhua Ngan, Foster City, CA (US); Chiu Wah So, Saratoga, CA (US); Nitya Kannan Tarakad, Belmont, CA (US)

(21) Appl. No.: 18/651,540

(22) Filed: Apr. 30, 2024

(51) Int. Cl. G06F 16/2453; G06F 16/242; G06F 16/2455

(52) U.S. Cl. CPC G06F 16/24535; G06F 16/243; G06F 16/2456

(57) ABSTRACT

Some embodiments include information retrieval through query history insights by accessing query history of a first user, processing the query history of the first user using a first machine learning model to identify naming characteristics of the query history specific for the first user, and enriching a database comprising data associated with the first user with the identified naming characteristics of the query history. The system receives a new search query in natural language from the first user, processes the new search query in the natural language using a second machine learning model to identify embeddings within the new search query, identifies one or more recommended tables and corresponding columns, and causes display of the recommended tables and corresponding columns for each of the recommended tables by a user device of the first user.

### TECHNICAL FIELD

Embodiments of the disclosure relate generally to information retrieval and, more specifically, information retrieval through query history insights.

### BACKGROUND

Queries in cloud computing platforms refer to the process of retrieving specific information or performing actions within a cloud-based environment. These queries can range from simple data retrieval requests to complex operations involving multiple services or resources. Cloud providers offer query languages and tools tailored to their platforms, enabling users to interact with cloud services, databases, and applications efficiently. Commonly used query languages include SQL for relational databases, NoSQL queries for non-relational databases, and APIs for accessing cloud services programmatically. Effective query management is crucial for optimizing performance, ensuring data integrity, and meeting business objectives in cloud-based environments.

### BRIEF DESCRIPTION OF THE SEVERAL VIEWS OF THE DRAWINGS

The present disclosure will be apparent from the following more particular description of examples of embodiments of the technology, as illustrated in the accompanying drawings. The drawings are not necessarily to scale, emphasis instead being placed upon illustrating embodiments of the present disclosure. In the drawings, like numerals may describe similar components in different views. Like numerals having different letter suffixes may represent different instances of similar components. Various ones of the appended drawings merely illustrate example embodiments of the present disclosure and should not be considered as limiting its scope.

FIG. 1 illustrates an example computing environment in which a cloud data platform, in communication with a cloud storage platform, can implement information retrieval through query history insights, according to some example embodiments.

FIG. 2 is a block diagram illustrating components of a compute service manager, according to some examples.

FIG. 3 is a block diagram illustrating components of an execution platform, according to some examples.

FIG. 4 illustrates an example method for information retrieval through query history insights, according to some examples

FIG. 5 illustrates an architectural diagram illustrating the generation of query history insights, according to some examples.

FIG. 6 illustrates an architectural diagram illustrating the generation of embeddings to recommend tables and columns according to some examples.

FIG. 7 is a user interface illustrating a natural language query and resulting table and column recommendations, according to some examples.

FIG. 8 illustrates training and use of a machine-learning program, according to some examples.

FIG. 9 illustrates a machine-learning pipeline, according to some examples.

FIG. 10 illustrates an example diagrammatic representation of a machine in the form of a computer system within which a set of instructions may be executed for causing the machine to perform any one or more of the methodologies discussed herein, according to some examples.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail. For the purposes of this description, the phrase “cloud data platform” may be referred to as and used interchangeably with the phrases “a network-based database system,” “a database system,” or merely “a platform.”

At present, traditional systems that recommend tables and columns based on a query can face several technical pitfalls. Traditional systems often rely on keyword matching or basic syntactic analysis, leading to limited semantic understanding of user queries. This approach may overlook nuances, synonyms, or context-specific meanings, resulting in less accurate recommendations.

Moreover, traditional systems struggle to capture and consider the broader context of user queries, including historical interactions, user preferences, data relationships, and business rules. This can lead to recommendations that are not contextually relevant or aligned with user intent.

Traditional systems may use simplistic matching algorithms that prioritize exact keyword matches or simple rules, leading to suboptimal recommendations. These algorithms may fail to capture complex relationships, patterns, or user preferences effectively.

Traditional systems also have limited capabilities to integrate and analyze diverse data sources, metadata, and user feedback. This can result in incomplete or outdated information being used for recommendations, reducing their accuracy and relevance.

Traditional systems further struggle with scalability and performance when handling large volumes of data, complex queries, and real-time processing requirements. This can lead to slower response times, resource constraints, and scalability limitations.

Without advanced machine learning and AI capabilities, traditional systems may find it challenging to adapt and learn from user interactions, feedback, and changing data patterns. This can hinder the system's ability to improve over time and provide personalized recommendations.

To address these and other issues and shortcomings of prior implementations, disclosed herein are various examples of systems and methods for information retrieval through query history insights.

The data platform described herein leverages advanced natural language processing (NLP) techniques, including semantic analysis, entity recognition, and context modeling. By using a bi-encoder model, the data platform captures semantic relationships, synonyms, and contextual meanings in user queries and data elements. This enables a deeper semantic understanding, reducing the reliance on exact keyword matching and improving the accuracy of recommendations.

The data platform incorporates query history data, user interactions, data relationships, and business rules into the recommendation process. By analyzing past query patterns, user preferences, and contextual metadata, the data platform provides contextually relevant recommendations aligned with user intent and data context. This contextual awareness enhances the quality and relevance of recommended tables and columns.

The data platform employs advanced machine learning algorithms, specifically a cross-encoder model, to generate rankings and relevance scores for tables and columns. This model considers the entire query-context pair and learns complex relationships, patterns, and user preferences. By using sophisticated matching algorithms, the data platform ensures more accurate and personalized recommendations, surpassing the limitations of traditional matching approaches.

The data platform integrates diverse data sources, metadata, and user feedback through a unified data platform. The data platform enables comprehensive data analysis, including query history extraction, metadata enrichment, and signal aggregation. By leveraging a rich data environment, the data platform provides up-to-date and comprehensive information for recommendation generation, improving the quality and relevance of recommendations.

The data platform employs scalable infrastructure and optimized algorithms to address scalability and performance challenges. By leveraging distributed computing, parallel processing, and efficient data indexing, the data platform handles large volumes of data, complex queries, and real-time processing requirements. This ensures faster response times, minimal resource constraints, and scalability to meet growing demands.

The data platform incorporates continuous learning mechanisms, feedback loops, and model retraining capabilities. By analyzing user interactions, feedback, and changing data patterns, the data platform adapts and learns over time. This adaptive learning process improves the accuracy, relevance, and personalization of recommendations, ensuring that the data platform evolves and improves with user interactions.

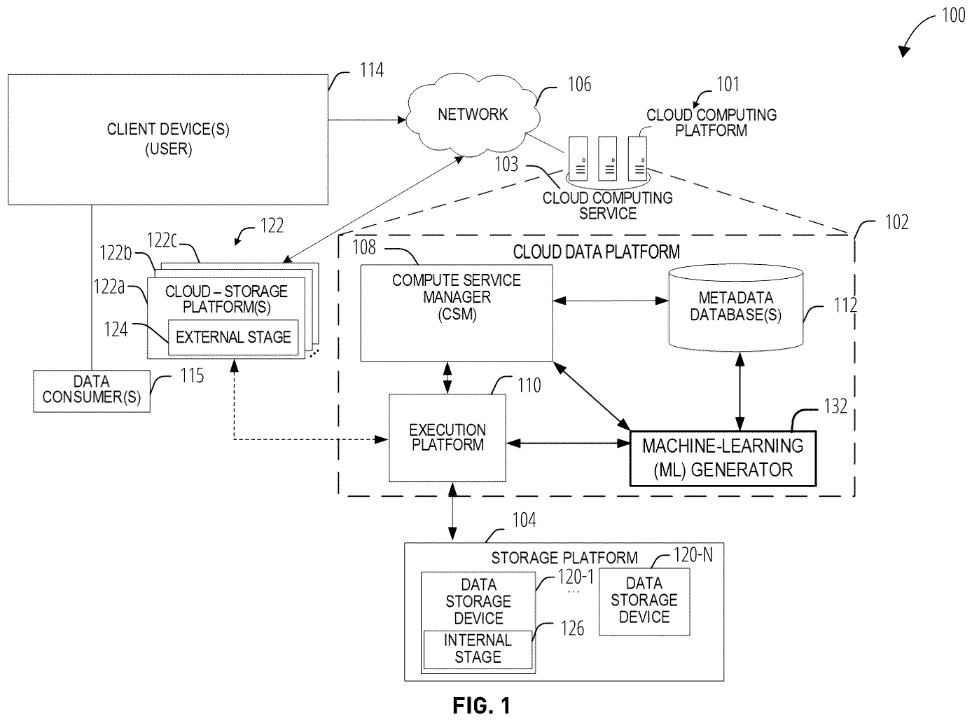

FIG. 1 illustrates an example computing environment 100 including a cloud data platform 102, which is in communication with a cloud storage platform and is using an organization-level account manager that supports organization-level accounts for organizations, in accordance with some embodiments of the present disclosure. To avoid obscuring the inventive subject matter with unnecessary detail, various functional components that are not germane to conveying an understanding of the inventive subject matter have been omitted from FIG. 1. However, a skilled artisan will readily recognize that various additional functional components may be included as part of the computing environment 100 to facilitate additional functionality that is not specifically described herein. In other embodiments, the computing environment may comprise another type of cloud data platform or a cloud data platform. For example, in some aspects, the computing environment 100 may include a cloud computing platform 101 with the cloud data platform 102 and a storage platform 104 (also referred to as a cloud storage platform). The cloud computing platform 101 provides computing resources and storage resources that can be acquired (purchased) or leased and configured to execute applications and store data.

The cloud computing platform 101 may host a cloud computing service 103 that facilitates storage of data on the cloud computing platform 101 (e.g., data management and access) and analysis functions (e.g., SQL queries, analysis), as well as other processing capabilities. The cloud computing platform 101 may include a three-tier architecture: data storage (e.g., storage platform 104 and storage platforms 122), an execution platform 110 (e.g., providing query processing), and a compute service manager 108 providing cloud services including services associated with the disclosed functionalities.

It is often the case that organizations that are users of a given data platform also maintain data storage (e.g., a data lake) that is external to the data platform (i.e., one or more external storage locations). For example, a company could be a user of a particular data platform and also separately maintain storage of any number of files—be they unstructured files, semi-structured files, structured files, and/or files of one or more other types—on, as examples, one or more of their servers and/or on one or more cloud-storage platforms such as AMAZON WEB SERVICES™ (AWS™), MICROSOFT® AZURE®, GOOGLE CLOUD PLATFORM™, and/or the like. The user's servers and cloud-storage platforms are both examples of what a given user could use as what is referred to herein as an external storage location. The cloud computing platform 101 could also use a cloud-storage platform as what is referred to herein as an internal storage location concerning the data platform.

From the perspective of the cloud data platform 102 of the cloud computing platform 101, one or more files that are stored at one or more storage locations are referred to herein as being organized into one or more of what is referred to herein as either “internal stages” or “external stages.” Internal stages are stages that correspond to data storage at one or more internal storage locations, and external stages are stages that correspond to data storage at one or more external storage locations. In this regard, external files can be stored in external stages at one or more external storage locations, and internal files can be stored in internal stages at one or more internal storage locations, which can include servers managed and controlled by the same organization (e.g., company) that manages and controls the data platform, and which can instead or in addition include data-storage resources operated by a storage provider (e.g., a cloud-storage platform) that is used by the data platform for its “internal” storage. The internal storage of a data platform is also referred to herein as the “storage platform” of the data platform. It is further noted that a given external file that a given user stores at a given external storage location may or may not be stored in an external stage in the external storage location; in some data-platform implementations, it is a user's choice whether to create one or more external stages (e.g., one or more external-stage objects) in the user's data-platform account as an organizational and functional construct for conveniently interacting via the data platform with one or more external files.

As shown, the cloud data platform 102 of the cloud computing platform 101 is in communication with the storage platforms 104 and 122 (e.g., AWS®, Microsoft Azure Blob Storage®, or Google Cloud Storage). The cloud data platform 102 is a network-based system used for reporting and analysis of integrated data from one or more disparate sources including one or more storage locations within the storage platform 104. The storage platform 104 comprises a plurality of computing machines and provides on-demand computer system resources such as data storage and computing power to the cloud data platform 102.

The cloud data platform 102 comprises a compute service manager 108, an execution platform 110, and one or more metadata databases 112. The cloud data platform 102 hosts and provides data reporting and analysis services to multiple client accounts.

The compute service manager 108 coordinates and manages operations of the cloud data platform 102. The compute service manager 108 also performs query optimization and compilation as well as managing clusters of computing services that provide compute resources (also referred to as “virtual warehouses”). The compute service manager 108 can support any number of client accounts such as end-users providing data storage and retrieval requests, system administrators managing the systems and methods described herein, and other components/devices that interact with compute service manager 108.

The compute service manager 108 is also in communication with a client device 114. The client device 114 corresponds to a user of one of the multiple client accounts supported by the cloud data platform 102. A user may utilize the client device 114 to submit data storage, retrieval, and analysis requests to the compute service manager 108. Client device 114 (also referred to as a user device) may include one or more of a laptop computer, a desktop computer, a mobile phone (e.g., a smartphone), a tablet computer, a cloud-hosted computer, cloud-hosted serverless processes, or other computing processes or devices that may be used to access services provided by the cloud computing platform 101 (e.g., cloud computing service 103) by way of a network 106, such as the Internet or a private network. In some embodiments, the user of the client device 114 can be a data provider configured to provide services to other users such as data consumers 115.

In the description below, actions are ascribed to users of the cloud data platform. Such actions shall be understood to be performed concerning client device 114 (or multiple client devices) operated by such users. For example, a notification to a user may be understood to be a notification transmitted to the client device 114, input or instruction from a user may be understood to be received by way of the client device 114, and interaction with an interface by a user shall be understood to be interaction with the interface on the client device 114. In addition, database operations (e.g., joining, aggregating, analysis, etc.) ascribed to a user of the cloud data platform shall be understood to include performing such actions by the cloud computing service 103 in response to an instruction from that user.

The compute service manager 108 is also coupled to one or more metadata databases 112 that store metadata about various functions and aspects associated with the cloud data platform 102 and its users. For example, the one or more metadata databases 112 may include a summary of data stored in remote data storage systems as well as data available from a local cache. Additionally, the one or more metadata databases 112 may include information regarding how data is organized in remote data storage systems (e.g., the storage platform 104) and the local caches. Information stored by the one or more metadata databases 112 allows systems and services to determine whether a piece of data needs to be accessed without loading or accessing the actual data from a storage device. In some embodiments, the one or more metadata databases 112 are configured to store account object metadata (e.g., account objects used in connection with a replication group object).

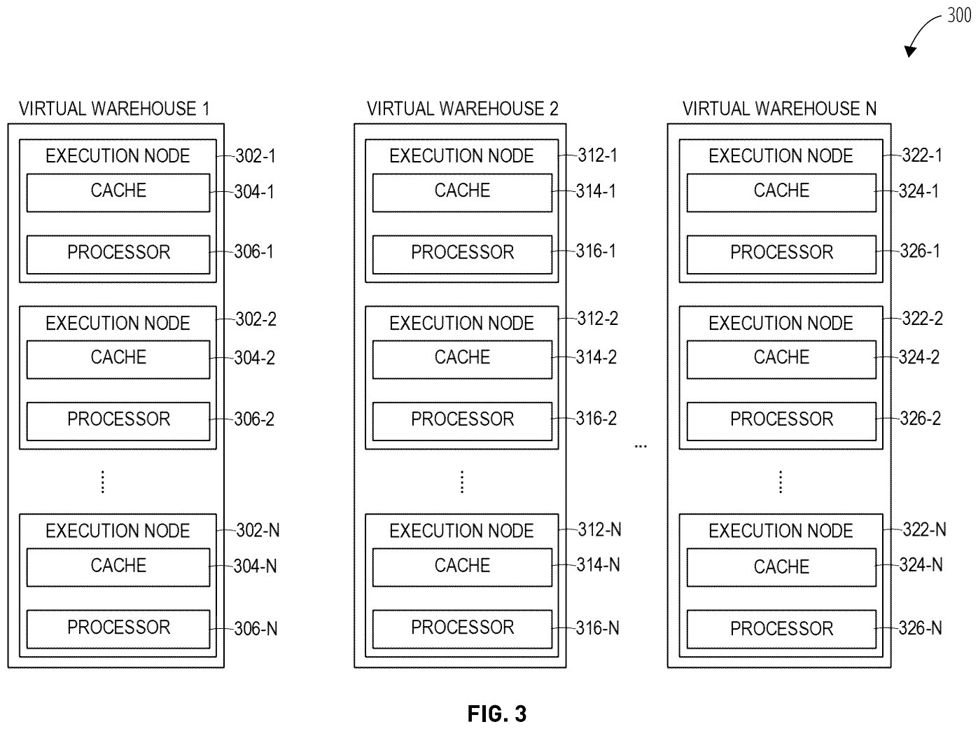

The compute service manager 108 is further coupled to the execution platform 110, which provides multiple computing resources that execute various data storage and data retrieval tasks. As illustrated in FIG. 3, the execution platform 110 comprises a plurality of compute nodes. The execution platform 110 is coupled to storage platform 104 and cloud-storage platforms 122A, 122B, . . . , 122C (collectively referred to as storage platforms 122). The storage platform 104 comprises multiple data storage devices 120-1 to 120-N. In some embodiments, the data storage devices 120-1 to 120-N are cloud-based storage devices located in one or more geographic locations. For example, the data storage devices 120-1 to 120-N may be part of a public cloud infrastructure or a private cloud infrastructure. The data storage devices 120-1 to 120-N may be hard disk drives (HDDs), solid-state drives (SSDs), storage clusters, Amazon S3™ storage systems, or any other data-storage technology. Additionally, the storage platform 104 may include distributed file systems (such as Hadoop Distributed File Systems (HDFS)), object storage systems, and the like. In some embodiments, at least one internal stage 126 may reside on one or more of the data storage devices 120-1-120-N, and an external stage 124 may reside on one or more of the storage platforms 122.

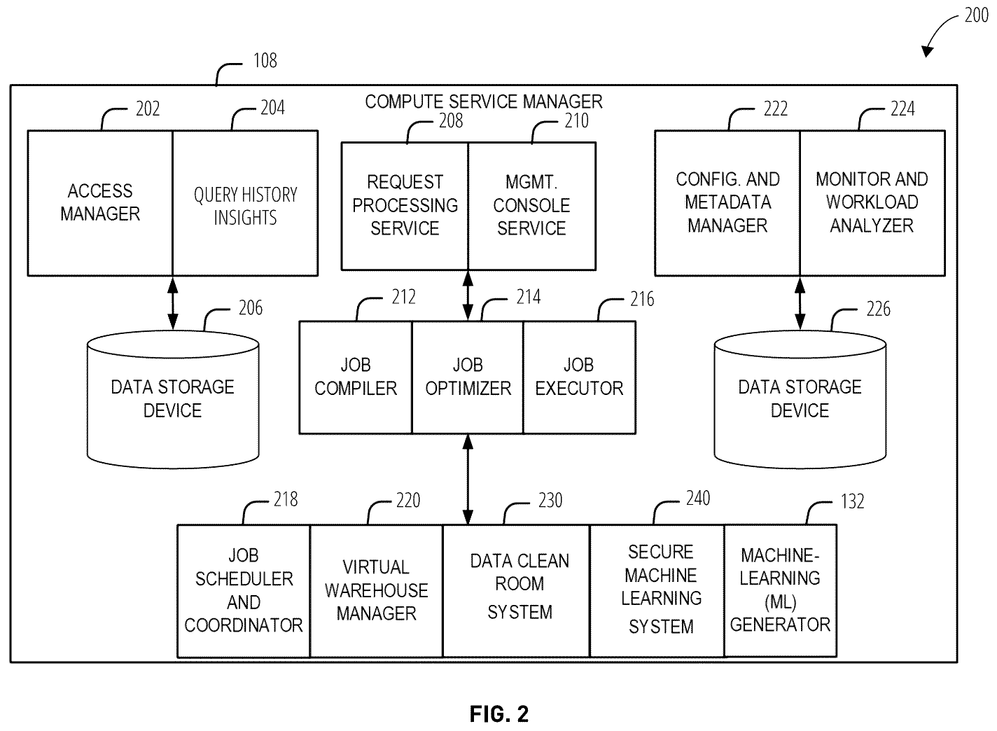

In some embodiments, the cloud data platform 102 includes a machine-learning (ML) generator 132. The ML generator 132 comprises suitable circuitry, interfaces, logic, and/or code and is configured to provide generation of ML models for extracting information from one or more documents (e.g., electronic documents) according to various embodiments. In some embodiments, the ML generator 132 can include one or more system functions that can be used to implement a method of generating an ML model as described herein. In some examples, the ML generator 132 can be operatively interconnected to the compute service manager 108, within the compute service manager 108 (as depicted in FIG. 2), connected to the execution platform 110, connected to the meta database(s) 112, or otherwise connected within or operatively to the cloud data platform 102 via additional external connections.

The execution platform 110 comprises a plurality of compute nodes. A set of processes on a compute node executes a query plan compiled by the compute service manager 108. The set of processes can include: a first process to execute the query plan; a second process to monitor and delete cache files using a least recently used (LRU) policy and implement an out of memory (OOM) error mitigation process; a third process that extracts health information from process logs and status to send back to the compute service manager 108; a fourth process to establish communication with the compute service manager 108 after a system boot; and a fifth process to handle all communication with a compute cluster for a given job provided by the compute service manager 108 and to communicate information back to the compute service manager 108 and other compute nodes of the execution platform 110.

In some embodiments, communication links between elements of the computing environment 100 are implemented via one or more data communication networks. These data communication networks may utilize any communication protocol and any type of communication medium. In some embodiments, the data communication networks are a combination of two or more data communication networks (or sub-networks) coupled to one another. In alternate embodiments, these communication links are implemented using any type of communication medium and any communication protocol.

The compute service manager 108, the one or more metadata databases 112, the execution platform 110, and the storage platform 104, are shown in FIG. 1 as individual discrete components. However, each of the compute service manager 108, the one or more metadata databases 112, execution platform 110, and storage platform 104 may be implemented as a distributed system (e.g., distributed across multiple systems/platforms at multiple geographic locations). Additionally, each of the compute service manager 108, the one or more metadata databases 112, execution platform 110, and storage platform 104 can be scaled up or down (independently of one another) depending on changes to the requests received and the changing needs of the cloud data platform 102. Thus, in the described embodiments, the cloud data platform 102 is dynamic and supports regular changes to meet the current data processing needs.

During a typical operation, the cloud data platform 102 processes multiple jobs determined by the compute service manager 108. These jobs are scheduled and managed by the compute service manager 108 to determine when and how to execute the job. For example, the compute service manager 108 may divide the job into multiple discrete tasks and may determine what data is needed to execute each of the multiple discrete tasks. The compute service manager 108 may assign each of the multiple discrete tasks to one or more nodes of the execution platform 110 to process the task. The compute service manager 108 may determine what data is needed to process a task and further determine which nodes within the execution platform 110 are best suited to process the task. Some nodes may have already cached the data needed to process the task and, therefore, be good candidates for processing the task. Metadata stored in the one or more metadata databases 112 assists the compute service manager 108 in determining which nodes in the execution platform 110 have already cached at least a portion of the data needed to process the task. One or more nodes in the execution platform 110 process the task using data cached by the nodes and, if necessary, data retrieved from the storage platform 104. It is desirable to retrieve as much data as possible from caches within the execution platform 110 because the retrieval speed is typically much faster than retrieving data from the storage platform 104.

As shown in FIG. 1, the cloud computing platform 101 of the computing environment 100 separates the execution platform 110 from the storage platform 104. In this arrangement, the processing resources and cache resources in the execution platform 110 operate independently of the data storage devices 120-1 to 120-N in the storage platform 104. Thus, the computing resources and cache resources are not restricted to specific data storage devices 120-1 to 120-N. Instead, all computing resources and all cache resources may retrieve data from, and store data to, any of the data storage resources in the storage platform 104.

FIG. 2 is a block diagram 200 illustrating components of the compute service manager 108, in accordance with some embodiments of the present disclosure. As shown in FIG. 2, the compute service manager 108 includes an access manager 202 and a query history insights 204 coupled to data storage device 206, which is an example of the metadata databases 112. Access manager 202 handles authentication and authorization tasks for the systems described herein.

The query history insights 204 facilitates assessment of historical query information to generate insights. As used herein, the remote storage devices may also be referred to as “persistent storage devices” or “shared storage devices.” For example, the query history insights 204 may create and maintain insights from past query requests (e.g., in the data storage device 206), as further described herein.

A request processing service 208 manages received data storage requests and data retrieval requests (e.g., jobs to be performed on database data). For example, the request processing service 208 may determine the data to process a received query (e.g., a data storage request or data retrieval request). The data may be stored in a cache within the execution platform 110 or in a data storage device in cloud storage platform 104.

A management console service 210 supports access to various systems and processes by administrators and other system managers. Additionally, the management console service 210 may receive a request to execute a job and monitor the workload on the system.

The compute service manager 108 also includes a job compiler 212, a job optimizer 214, and a job executor 216. The job compiler 212 parses a job into multiple discrete tasks and generates the execution code for each of the multiple discrete tasks. The job optimizer 214 determines the best method to execute the multiple discrete tasks based on the data that needs to be processed. The job optimizer 214 also handles various data pruning operations and other data optimization techniques to improve the speed and efficiency of executing the job. The job executor 216 executes the execution code for jobs received from a queue or determined by the compute service manager 108.

A job scheduler and coordinator 218 sends received jobs to the appropriate services or systems for compilation, optimization, and dispatch to the execution platform 110 of FIG. 1. For example, jobs may be prioritized and then processed in the prioritized order. In an embodiment, the job scheduler and coordinator 218 determines a priority for internal jobs that are scheduled by the compute service manager 108 of FIG. 1 with other “outside” jobs such as user queries that may be scheduled by other systems in the database but may utilize the same processing resources in the execution platform 110. In some embodiments, the job scheduler and coordinator 218 identifies or assigns particular nodes in the execution platform 110 to process particular tasks. A virtual warehouse manager 220 manages the operation of multiple virtual warehouses implemented in the execution platform 110. For example, the virtual warehouse manager 220 may generate query plans for executing received queries, requests, or the like.

As illustrated, the compute service manager 108 includes a configuration and metadata manager 222, which manages the information related to the data stored in the remote data storage devices and in the local buffers (e.g., the buffers in execution platform 110). The configuration and metadata manager 222 uses metadata to determine which data files need to be accessed to retrieve data for processing a particular task or job. A monitor and workload analyzer 224 oversees processes performed by the compute service manager 108 and manages the distribution of tasks (e.g., workload) across the virtual warehouses and execution nodes in the execution platform 110. The monitor and workload analyzer 224 also redistributes tasks, as needed, based on changing workloads throughout the cloud data platform 102 and may further redistribute tasks based on a user (e.g., “external”) query workload that may also be processed by the execution platform 110. The configuration and metadata manager 222 and the monitor and workload analyzer 224 are coupled to a data storage device 226. Data storage device 226 represents any data storage device within the cloud data platform 102. For example, data storage device 226 may represent buffers in execution platform 110, storage devices in cloud storage platform 104, or any other storage device.

As described in embodiments herein, the compute service manager 108 validates all communication from an execution platform (e.g., the execution platform 110) to validate that the content and context of that communication are consistent with the task(s) known to be assigned to the execution platform. For example, an instance of the execution platform executing a query A should not be allowed to request access to data-source D (e.g., data storage device 226) that is not relevant to query A. Similarly, a given execution node (e.g., execution node 302-1 of FIG. 3) may need to communicate with another execution node (e.g., execution node 302-2 of FIG. 3), but should be disallowed from communicating with a third execution node (e.g., execution node 312-1), and any such illicit communication can be recorded (e.g., in a log or other location). Also, the information stored on a given execution node is restricted to data relevant to the current query, and any other data is unusable, rendered so by destruction or encryption where the key is unavailable.

The data clean room system 230 allows for dynamically restricted data access to shared datasets. Data clean room is one part of data sharing and is just one example of the marketplace.

As previously mentioned, the compute service manager 108 can include the ML generator 132 and/or be operatively interconnected to the ML generator 132 configured to generate ML model for extracting information from one or more documents according to various embodiments. As explained throughout, in some example embodiments, the ML generator 132 can be integrated into a database clean room, and/or used in conjunction with, parallel to, or in combination with a secure machine learning system 240 as depicted and described above with reference to FIG. 2. The database clean room enables two or more end-users of the cloud data platform 102 to share and collaborate on their sensitive data, without directly revealing that data to other participants. In alternative example embodiments, the ML generator 132 can be configured externally from compute service manager 108 and from cloud data platform 102, instead being operatively interconnected via one or more layers.

FIG. 3 is a block diagram 300 illustrating components of the execution platform 110 of FIG. 1, in accordance with some embodiments of the present disclosure. As shown in FIG. 3, the execution platform 110 includes multiple virtual warehouses, including virtual warehouse 1, virtual warehouse 2, and virtual warehouse N. Each virtual warehouse includes multiple execution nodes that each include a data cache and a processor. The virtual warehouses can execute multiple tasks in parallel by using the multiple execution nodes. As discussed herein, the execution platform 110 can add new virtual warehouses and drop existing virtual warehouses in real-time based on the current processing needs of the systems and users. This flexibility allows the execution platform 110 to quickly deploy large amounts of computing resources when needed without being forced to continue paying for those computing resources when they are no longer needed. All virtual warehouses can access data from any data storage device (e.g., any storage device in cloud storage platform 104).

Although each virtual warehouse shown in FIG. 3 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer useful.

Each virtual warehouse is capable of accessing any of the data storage devices 120-1 to 120-N shown in FIG. 1. Thus, the virtual warehouses are not necessarily assigned to a specific data storage device 120-1 to 120-N and, instead, can access data from any of the data storage devices 120-1 to 120-N within the cloud storage platform 104. Similarly, each of the execution nodes shown in FIG. 3 can access data from any of the data storage devices 120-1 to 120-N. In some embodiments, a particular virtual warehouse or a particular execution node may be temporarily assigned to a specific data storage device, but the virtual warehouse or execution node may later access data from any other data storage device.

In the example of FIG. 3, virtual warehouse 1 includes three execution nodes 302-1, 302-2, and 302-N. Execution node 302-1 includes a cache 304-1 and a processor 306-1. Execution node 302-2 includes a cache 304-2 and a processor 306-2. Execution node 302-N includes a cache 304-N and a processor 306-N. Each execution node 302-1, 302-2, and 302-N is associated with processing one or more data storage and/or data retrieval tasks. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

Similar to virtual warehouse 1 discussed above, virtual warehouse 2 includes three execution nodes 312-1, 312-2, and 312-N. Execution node 312-1 includes a cache 314-1 and a processor 316-1. Execution node 312-2 includes a cache 314-2 and a processor 316-2. Execution node 312-N includes a cache 314-N and a processor 316-N. Additionally, virtual warehouse 3 includes three execution nodes 322-1, 322-2, and 322-N. Execution node 322-1 includes a cache 324-1 and a processor 326-1. Execution node 322-2 includes a cache 324-2 and a processor 326-2. Execution node 322-N includes a cache 324-N and a processor 326-N.

In some embodiments, the execution nodes shown in FIG. 3 are stateless with respect to the data being cached by the execution nodes. For example, these execution nodes do not store or otherwise maintain state information about the execution node, or the data being cached by a particular execution node. Thus, in the event of an execution node failure, the failed node can be transparently replaced by another node. Since there is no state information associated with the failed execution node, the new (replacement) execution node can easily replace the failed node without concern for recreating a particular state.

Although the execution nodes shown in FIG. 3 each include one data cache and one processor, alternate embodiments may include execution nodes containing any number of processors and any number of caches. Additionally, the caches may vary in size among the different execution nodes. The caches shown in FIG. 3 store, in the local execution node, data that was retrieved from one or more data storage devices in cloud storage platform 104 of FIG. 1. Thus, the caches reduce or eliminate the bottleneck problems occurring in platforms that consistently retrieve data from remote storage systems. Instead of repeatedly accessing data from the remote storage devices, the systems and methods described herein access data from the caches in the execution nodes, which is significantly faster and avoids the bottleneck problem discussed above. In some embodiments, the caches are implemented using high-speed memory devices that provide fast access to the cached data. Each cache can store data from any of the storage devices in the cloud storage platform 104.

Further, the cache resources and computing resources may vary between different execution nodes. For example, one execution node may contain significant computing resources and minimal cache resources, making the execution node useful for tasks that require significant computing resources. Another execution node may contain significant cache resources and minimal computing resources, making this execution node useful for tasks that require caching of large amounts of data. Yet, another execution node may contain cache resources providing faster input-output operations, useful for tasks that require fast scanning of large amounts of data. In some embodiments, the cache resources and computing resources associated with a particular execution node are determined when the execution node is created, based on the expected tasks to be performed by the execution node.

Additionally, the cache resources and computing resources associated with a particular execution node may change over time based on changing tasks performed by the execution node. For example, an execution node may be assigned more processing resources if the tasks performed by the execution node become more processor intensive. Similarly, an execution node may be assigned more cache resources if the tasks performed by the execution node require a larger cache capacity.

Although virtual warehouses 1, 2, and N are associated with the same execution platform 110, the virtual warehouses may be implemented using multiple computing systems at multiple geographic locations. For example, virtual warehouse 1 can be implemented by a computing system at a first geographic location, while virtual warehouses 2 and N are implemented by another computing system at a second geographic location. In some embodiments, these different computing systems are cloud-based computing systems maintained by one or more different entities.

Additionally, each virtual warehouse is shown in FIG. 3 as having multiple execution nodes. The multiple execution nodes associated with each virtual warehouse may be implemented using multiple computing systems at multiple geographic locations. For example, an instance of virtual warehouse 1 implements execution nodes 302-1 and 302-2 on one computing platform at a geographic location and implements execution node 302-N at a different computing platform at another geographic location. Selecting particular computing systems to implement an execution node may depend on various factors, such as the level of resources needed for a particular execution node (e.g., processing resource requirements and cache requirements), the resources available at particular computing systems, communication capabilities of networks within a geographic location or between geographic locations, and which computing systems are already implementing other execution nodes in the virtual warehouse.

Execution platform 110 is also fault tolerant. For example, if one virtual warehouse fails, that virtual warehouse is quickly replaced with a different virtual warehouse at a different geographic location. A particular execution platform 110 may include any number of virtual warehouses. Additionally, the number of virtual warehouses in a particular execution platform is dynamic, such that new virtual warehouses are created when additional processing and/or caching resources are needed. Similarly, existing virtual warehouses may be deleted when the resources associated with the virtual warehouse are no longer useful.

In some embodiments, the virtual warehouses may operate on the same data in cloud storage platform 104, but each virtual warehouse has its own execution nodes with independent processing and caching resources. This configuration allows requests on different virtual warehouses to be processed independently and with no interference between the requests. This independent processing, combined with the ability to dynamically add and remove virtual warehouses, supports the addition of new processing capacity for new users without impacting the performance.

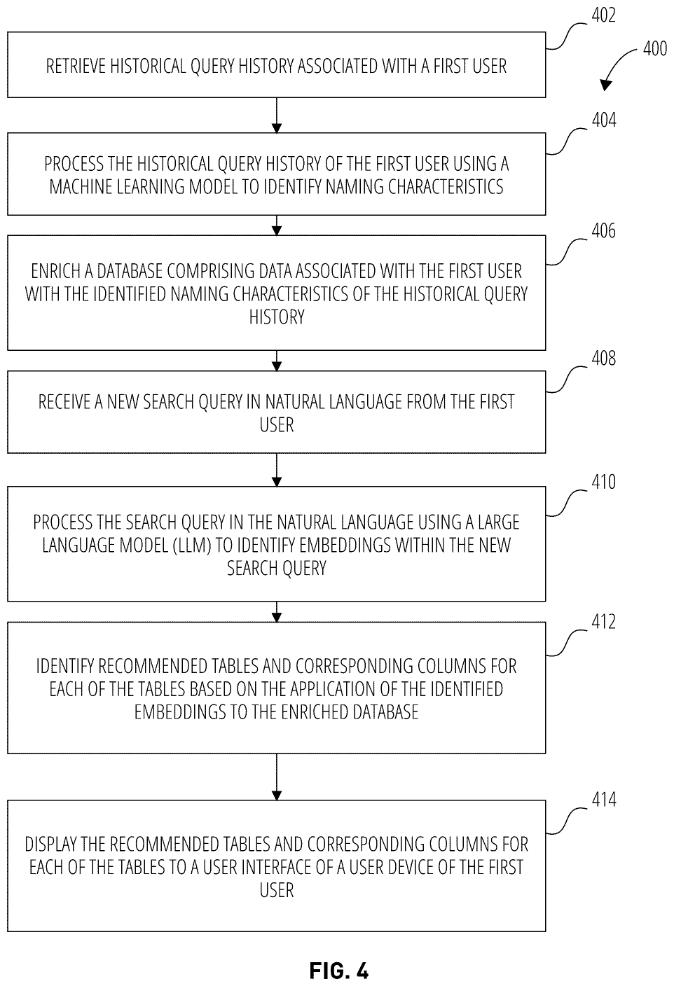

FIG. 4 illustrates an example flow diagram 400 illustrating information retrieval through query history insights, according to some example embodiments. Although the example flow diagram 400 depicts a particular sequence of operations, the sequence may be altered without departing from the scope of the present disclosure. For example, some of the operations depicted may be performed in parallel or in a different sequence that does not materially affect the function of the flow diagram 400. In other examples, different components of an example device or system that implements the flow diagram 400 may perform functions at substantially the same time or in a specific sequence.

At operation 402, the data platform retrieves query history associated with a first user. As for retrieving query history associated with a first user, the data platform accesses and collects query history data, such as query data generated by a specific user over a defined period, such as the past year.

The query history includes a subset or all the queries made by the user. In some cases, the query history includes SQL queries. In some cases, the query history includes natural language prompts used for querying data within the cloud computing platform. This data could be stored in a database or a data storage system associated with the cloud platform.

The query history data can include details such as timestamps (e.g., when each query was made, indicating the temporal sequence of the user's interactions), query content (e.g., the actual text or content of the queries made by the user, which may include natural language prompts, SQL queries, or other types of requests), query outcomes (e.g., information about what data or results were retrieved or acted upon as a result of each query), contextual metadata (e.g., additional information such as the user's session details, device used, location, and any other relevant contextual data associated with each query), and the like.

The retrieval process may involve querying the data platform's logging or auditing systems to extract this historical data. In some cases, the process may also include accessing specific user profiles or accounts within the platform to gather user-specific query history.

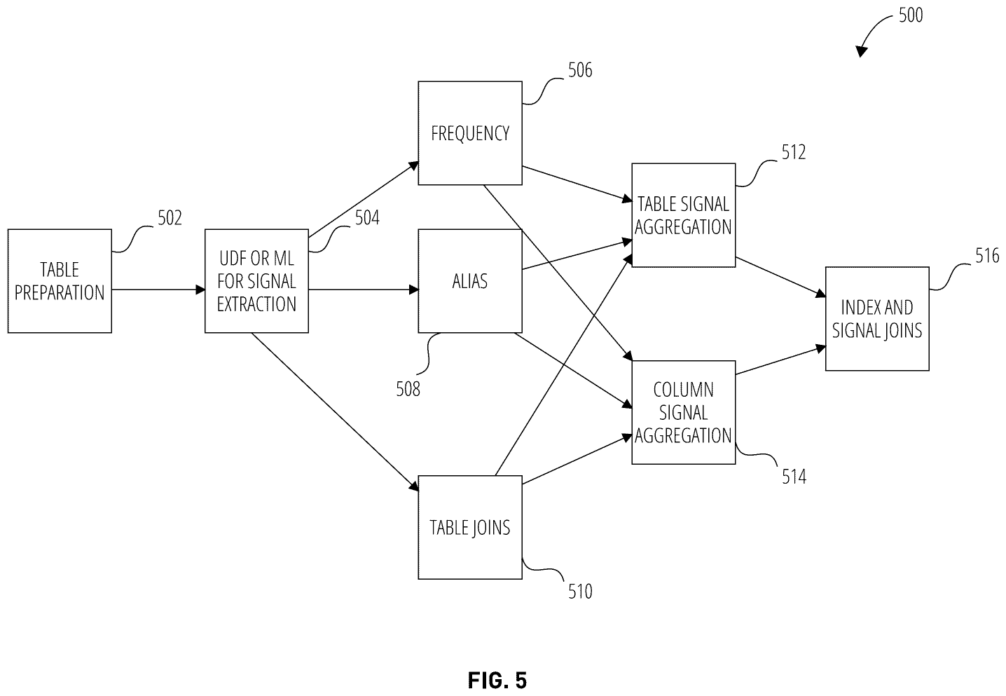

FIG. 5 illustrates an architectural diagram 500 illustrating the generation of query history insights, according to some examples. As the query history data is gathered in operation 402 of FIG. 4, the data platform can prepare the data tables for assessment. The collected query history data may be performed by the data platform. The data platform may prepare input tables 502 by undergoing cleaning processes to remove any noise or irrelevant information. This can include removing duplicate queries, filtering out incomplete or erroneous data entries, removing query literals, removing customer data that may have opted out of this feature, and standardizing data formats for consistency.

The data may be normalized to ensure uniformity in representation. For example, timestamps may be converted to a standard time zone format, and query text may be normalized to lowercase or a specific encoding format to facilitate analysis.

As part of preparing the data, the data platform can create or update data tables that will be used for assessing the query history. These data tables are structured to store and organize the extracted features and relevant information derived from the historical query data. Each table may correspond to different aspects of the query history, such as query content, timestamps, user identifiers, and derived characteristics like query patterns or common terms.

The data tables can be indexed and organized for efficient access and retrieval during the assessment phase. Indexing may involve creating indexes on key columns to speed up query processing and optimize search operations. The organization of data tables ensures that related data is stored together, facilitating data analysis and assessment tasks.

In some cases, metadata enrichment may occur during this phase. This involves enhancing the data tables with additional metadata or annotations that provide context or insights into the query history. For example, metadata tags may indicate the query type (e.g., SQL query, natural language query), user preferences, or query complexity.

Returning to FIG. 4, at operation 404, the data platform processes the query history of the first user. In some cases, the data platform processes the query history using a user defined function that is programmed to identify naming characteristics. In other cases, the data platform uses a machine learning model trained to identify naming characteristics of the query history. For example, a first user may refer to certain tables or columns using a certain naming convention in a past SQL query. The machine learning model may be trained to identify such naming characteristics of query histories.

The purpose of using a machine learning model is to analyze and identify naming characteristics specific to the user's query history. This includes patterns, trends, preferences, and variations in how the user formulates queries, including naming conventions for tables, columns, services, and other elements within the cloud computing platform. The machine learning model can identify aliases (e.g., other naming conventions referring to the same name) based on such history data.

The machine learning model is trained using the user's historical query data as input. The training process can include feature extraction by extracting relevant features from the historical query data that can help in identifying naming characteristics. Features could include word frequencies, n-grams (sequences of words), semantic embeddings, syntactic structures, and contextual information.

The data platform can use supervised or unsupervised learning techniques, such as classification, clustering, or sequence modeling, to train the model on the prepared data. The model learns to recognize patterns and associations within the query history that are indicative of the user's naming characteristics. The machine learning model may leverage various algorithms and methodologies, such as natural language processing (NLP), deep learning, neural networks, or statistical models, depending on the complexity and nature of the historical query data.

Once the machine learning model is trained, the data platform can effectively identify naming characteristics specific to the user's query history. This includes recognizing aliases, abbreviations, variations in terminology, common phrases, frequently used keywords, and other patterns that define how the user refers to data entities (such as tables, columns) and concepts within the cloud platform.

The output of this processing step is a set of learned naming characteristics and patterns associated with the user's query history. These insights are crucial for enhancing the data platform's ability to understand and interpret the user's natural language queries accurately and efficiently, as described in subsequent steps of the method.

An example of the data platform processing historical query history is the user defined function (UDF) or machine learning (ML) model for signal extraction 504 of FIG. 5. A UDF includes a custom function or procedure created by a developer to perform specific operations on data. In the context of signal extraction from query history, a UDF can be designed to extract signals or patterns based on predefined rules, algorithms, or heuristics.

The UDF takes query history data as input, such as in the form of structured data tables prepared during operation 402. The UDF includes logic to extract signals or features from the input data.

This logic can include frequency analysis 506 (e.g., identifying frequently used terms, keywords, or phrases in queries). Frequency metrics indicate which columns within tables or which tables are most frequently accessed or used in queries. Understanding popular columns can guide query optimization and indexing strategies.

For example, if a specific column, such as “CustomerID” or “ProductCode,” is consistently referenced in a large number of queries, it indicates that this column is popular and frequently used. The data platform records this popularity metric, which can influence query optimization decisions, indexing priorities, and data caching strategies.

The signal extractions and insights can include alias variations 508 which refer to alternative terms or expressions used by the user to refer to specific entities such as tables or columns in their queries. These variations are important to capture as they reflect the user's preferred language or terminology, and can identify relevant columns or tables when the query does not specify the exact naming convention of the column or table.

The signal extraction process can identify alias variations by analyzing the historical query history for instances where the user refers to the same entity using different terms. If the historical queries show that the user commonly references the “CA customers” table as “XP California customers,” this variation can be identified as an alias. The signal extraction mechanism records this alias mapping so that when future queries use either term, the data platform recognizes them as referring to the same entity.

The signal extractions can include table join predictions 510, which involve predicting or identifying how many tables the data platform needs to join to answer a particular query accurately. This prediction is also based on analyzing past query patterns and understanding the data relationships in the database.

In some cases, the signal extractions can include column properties (e.g., group by, measure, filtering, etc.). The group-by input indicates how columns are grouped together in queries, often used in aggregate functions like SUM, COUNT, AVG, etc. Understanding groupings can help identify common aggregation patterns and user preferences for summarizing data.

Measures include numerical values or metrics used in calculations or analysis, such as sales revenue, quantities sold, or average customer ratings. Analyzing measures can reveal common metrics of interest and the types of calculations users frequently perform.

Filtering criteria specify conditions for selecting specific data subsets. Analyzing filtering conditions can provide insights into common criteria users use to narrow down data selections, such as date ranges, product categories, customer segments, etc.

Subquery aliases are used to identify and label subqueries within a larger SQL query. When multiple queries are combined into a single SQL statement, subquery aliases help distinguish each query's results and usage within the broader context. ML models can use subquery aliases to understand how users structure complex queries and the relationships between subqueries and their results.

The signal extractions can include common where clauses and expressions after redacting query literals. Redacting literals includes removing specific values or constants from where clauses or expressions, focusing instead on the structural patterns and conditions used for filtering. ML models can analyze common where clauses and expressions to identify frequently used filters, conditions, and data selection criteria.

ML models can learn from query history to understand which columns are commonly used for filtering data, indicating their importance in query processing and data retrieval. By filtering out query literals and focusing on actual data values, models can extract meaningful patterns and usage trends related to filtering conditions.

For example, a user frequently queries sales data to analyze revenue by product category. ML models analyzing query history can determine: that the user often groups sales data by product category to calculate total sales by category (e.g., group by); that the user frequently measures sales revenue, quantities sold, and average prices to assess product performance (e.g., measure); common filtering criteria including date ranges (e.g., monthly, quarterly); specific product categories and customer segments (e.g., retail, wholesale); if the user uses subqueries to calculate intermediate results (e.g., subquery to compute total sales per product). ML models can recognize and track these subquery aliases for better query understanding, and the like.

By extracting these signals, the data platform can enhance query understanding, improve query suggestions, optimize query processing, and provide more relevant and efficient data retrieval for users based on their historical query behaviors and preferences.

Machine learning models or rule-based algorithms can be trained to analyze the query history and infer the likelihood of table joins based on the types of queries and data accessed. If the historical queries frequently involve retrieving customer information along with order details, the data platform can learn that these queries typically require joining the “Customers” table with the “Orders” table. This prediction helps optimize query performance by pre-joining relevant tables when processing user queries.

In some cases, the UDF detects recurring query patterns or structures. This logic may involve certain assessments, such as sequence analysis (e.g., analyzing the sequence of words or tokens within queries to identify common sequences or patterns), token frequency analysis (e.g., counting the frequency of specific tokens or keywords across queries to identify commonly used terms), syntax parsing (e.g., parsing the syntax of queries to identify common query structures, such as SELECT statements, WHERE clauses, and JOIN operations), n-grams analysis (e.g., examining sequences of n contiguous words or tokens to identify recurring n-grams that represent common query patterns), regular expression matching (e.g., using regular expressions to match query patterns based on predefined rules or patterns), and the like.

In some cases, the UDF performs association mining by discovering correlations between query elements (e.g., tables, columns) and user behavior. The UDF can apply association rules based on metrics such as support, confidence, and lift. The support includes a rule that measures the frequency of occurrence of both antecedent and consequent in the dataset, a confidence of a rule that measures the reliability or strength of the association between antecedent and consequent, and the lift of a rule that indicates the strength of the association between antecedent and consequent, considering their individual support. High support, confidence, and lift values indicate strong associations between query elements and user behavior, making the rules more significant and actionable.

These rules reveal interesting patterns and relationships, such as queries frequently associated with specific tables or columns in the database, user behavior patterns based on query sequences, frequency of queries, or query combinations, and preferences or tendencies of users when interacting with the data platform, such as preferred search criteria, filtering options, or sorting preferences.

For example, in an e-commerce platform, association mining on historical query history data may reveal patterns such as: users who search for “electronics” are more likely to view products in the “electronics” category, queries containing brand names like “Apple” often lead to clicks on related product listings, and users who frequently search for “discounts” or “sales” tend to engage with promotional offers or special deals.

In some cases, the UDF performs semantic analysis by analyzing the meaning and context of queries to extract semantic signals. The UDF can employ one or more various techniques to understand the meaning and context of queries. The UDF can identify word embeddings representing words as dense vectors in a high-dimensional space to capture semantic relationships and similarities between words. The UDF can perform topic modeling by identifying underlying topics or themes in text data. The UDF can perform named entity recognition (NER) by identifying and categorizing named entities such as persons, organizations, locations, dates, and numerical entities mentioned in queries.

The UDF can perform sentiment analysis by determining the sentiment or emotion expressed in queries (positive, negative, neutral) to understand user attitudes and preferences. The UDF can perform intent detection by classifying queries into different intent categories (e.g., informational, navigational, transactional) to infer user goals and actions. The UDF can perform contextual analysis by analyzing the surrounding context of queries, including previous queries, user interactions, and session data, to derive meaning and relevance.

The UDF outputs the extracted signals, which may include metadata tags, signal scores, or enriched data representations that capture important characteristics of the query history. For example, a UDF is created to analyze query patterns in historical data. It identifies that a user often queries for sales data related to specific product categories, indicating a signal related to product interest. The UDF outputs this signal along with relevant metadata for further analysis.

In some cases, the data platform uses a machine learning model that is trained to automatically learn and extract signals or patterns from data. In the context of query history, machine learning models can leverage algorithms such as clustering, classification, or sequence modeling to extract meaningful signals.

Query history data is used as training data for the machine learning model. This data includes features extracted during operation 402, such as query content, timestamps, and contextual information. The machine learning model is trained using supervised or unsupervised learning techniques, depending on the nature of the signal extraction task. For example, the data platform can use supervised learning. If specific signal labels are available (e.g., predefined signal types), a supervised learning model can be trained to predict these signals based on input features.

In some cases, the data platform can use unsupervised learning. In cases where signal labels are not available, unsupervised learning techniques such as clustering or anomaly detection can be used to discover patterns and signals in an unsupervised manner.

Once trained, the model is capable of extracting signals from new or unseen data based on the learned patterns and associations. For example, a machine learning model, such as a recurrent neural network (RNN) trained on historical query data, learns to recognize patterns indicative of user preferences. The model identifies signals related to frequent access to financial data, customer profiles, and inventory information, which are then extracted and used for subsequent analysis or recommendations.

Both approaches, UDFs and machine learning models, can effectively perform signal extraction from query history data. The choice between these approaches depends on factors such as the complexity of signal extraction tasks, available training data, and desired automation levels within the data platform. In some cases, the platform can dynamically select between a UDF or machine learning model based on the characteristics of the signals desired, training data, and automation levels as described herein.

Although examples described herein refer to systems or applying certain processes using a UDF or ML model, it is appreciated that features described herein can be performed using one or more UDFs, one or more ML models, or a combination thereof.

Although examples described herein refer to systems or applying certain processes using a particular query, it is appreciated that features described herein can be performed using SQL queries, natural language queries, or a combination thereof.

Returning to FIG. 4, at operation 406, the data platform enriches a database comprising data associated with the first user with the identified naming characteristics of the query history. The enrichment process in operation 406 can include updating or enhancing the database associated with the first user to incorporate the identified naming characteristics.

Metadata associated with tables, columns, or other data entities in the database are updated to include aliases, alternative names, or naming variations identified from the query history. This metadata enrichment ensures that the database understands and recognizes the different ways the user refers to data elements.

A mapping or alias table may be created or updated within the database to establish relationships between original names and their corresponding aliases or variations. This mapping allows the data platform to translate queries using aliases into their actual database elements seamlessly.

Indexed tags or labels may be added to database elements based on their popularity, frequency of use, or relevance to the user's query history. This indexing and tagging help optimize search and retrieval operations within the database.

The database schema may be adjusted or updated to accommodate new aliases, naming conventions, or additional metadata attributes identified during the enrichment process. This ensures that the database structure reflects the user's naming characteristics accurately.

In summary, operation 406 involves updating the database with enriched metadata and naming characteristics derived from the user's query history. This enrichment improves query resolution, search optimization, and user experience within the database environment.

An example of enriching the database is described in FIG. 5. In this example, the data platform performs table signal aggregation 512 and column signal aggregation 514. Enriching the data with table signal aggregation 512 and column signal aggregation 514 involves aggregating and incorporating extracted signals into the database at both the table and column levels.

Table signal aggregation 512 can include gathering and summarizing signals or characteristics related to entire tables within the database. These signals can include metadata, usage patterns, aliases, popularity metrics, and other attributes derived from query history. The data platform analyzes query history to identify relevant signals and characteristics associated with each table. This can include aliases, frequently accessed columns, common join patterns, table popularity, and other table-level attributes.

The data platform aggregates the identified signals and characteristics into a comprehensive summary for each table. This aggregation process may involve calculating metrics such as frequency of use, popularity scores, join complexity, and metadata enrichment. The data platform updates the metadata of each table in the database to include the aggregated signals. This enriched metadata provides a holistic view of each table's properties, usage patterns, and relationships within the database ecosystem.

Column signal aggregation 514 focuses on summarizing signals or attributes specific to individual columns within tables. These signals can include data types, usage frequency, popularity metrics, filtering criteria, and semantic associations derived from query history. The data platform analyzes query history to identify signals and characteristics specific to each column, such as commonly used filters, aggregation functions, data types, and semantic associations.

The data platform aggregates the identified signals and attributes into a summary for each column. This aggregation may involve calculating metrics like usage frequency, filtering patterns, semantic relevance, and metadata enrichment at the column level. The data platform updates the metadata of each column in the database to include the aggregated signals. This enriched metadata provides detailed insights into each column's properties, usage patterns, and relevance in query processing.

After aggregating signals at the table and column levels, the data platform proceeds to index and perform signal joins 516 to integrate the aggregated data back into the database. Indexing can include creating data structures that facilitate efficient search and retrieval operations within the database. Indexes are created on columns or combinations of columns to speed up data access.

The data platform identifies indexable signals based on the aggregated table and column signals and determines which signals are suitable for indexing. These may include frequently used columns, popular filters, join patterns, and other query-relevant attributes. The data platform generates indexes for the identified signals to accelerate query performance. Indexes can be created using techniques like B-tree indexes, hash indexes, or specialized indexing methods depending on the data characteristics and query patterns. The data platform updates index metadata by maintaining metadata related to indexes, including index types, indexed columns, index sizes, and index maintenance schedules, which ensure optimal database performance.

Signal joins can include combining aggregated signals and metadata from different sources (tables, columns, external datasets) to enrich the database and enhance query processing. The data platform determines join conditions by defining join conditions based on the relationships between aggregated signals. For example, join conditions may specify how table-level signals relate to column-level signals or how aggregated metadata from different tables should be merged. The data platform performs signal joins using SQL JOIN operations or custom join algorithms to combine aggregated signals according to the defined join conditions. Signal joins integrate enriched metadata and signals back into the database structure, aligning them with existing data entities.

The data platform updates database schema by modifying the database schema to accommodate the integrated signals and metadata resulting from signal joins. This may involve adding new columns, updating table definitions, or incorporating external data sources. The data platform validates and optimizes joins by validating the integrity of signal joins and optimizes join performance using indexing, query optimization techniques, and data partitioning strategies.

After indexing and signal joins are completed, the enriched data, including aggregated signals and integrated metadata, is returned to the database. This enriched data becomes part of the database's schema and is available for query processing, data retrieval, and analytical operations. The returned data includes enhanced metadata, enriched signals, indexed attributes, and optimized join structures, which collectively improve the database's capabilities for intelligent query understanding, efficient data retrieval, and enhanced decision-making.

In summary, the data platform indexes relevant signals, performs signal joins to integrate aggregated data back into the database, updates the database schema as needed, and returns the enriched data to support advanced query processing, data analysis, and information retrieval within the database environment.

Returning to FIG. 4, at operation 408, the data platform receives a new search query in natural language from the first user. This operation involves the data platform receiving a new search query from the first user. The query is in natural language, meaning it is expressed in a way that is typical for human communication rather than using structured query languages like SQL. The first user inputs a search query using natural language. For example, the user may enter “Find sales data for last month” or “Show customer reviews for product X.”

At operation 410, the data platform processes the search query in the natural language using a machine learning model to identify embeddings within the new search query. In this operation, the data platform leverages a machine learning model to process the search query in natural language.

The search query is inputted into the machine learning model for deeper analysis and understanding. The machine learning model processes the query text to identify embeddings. Embeddings include numerical representations of words, phrases, or sentences in a high-dimensional vector space, capturing semantic and contextual relationships. In some cases, the machine learning model is used to parse the query, and the parsed query is inputted into a bi-encoder model that generates the embeddings. In some cases, the bi-encoder model is trained to generate the embeddings directly from the natural language search query.

Although the examples herein are described using a particular machine learning model, such as an LLM, it is appreciated that other machine learning models can be used, such as a bi-encoder model.

The LLM conducts semantic analysis on the query, considering factors such as entity recognition by identifying named entities like dates, product names, locations, etc.; intent detection by determining the user's intent behind the query (e.g., informational, navigational, transactional); and contextual understanding by considering contextual cues and previous interactions to refine understanding. The machine learning model, such as a bi-encoder model, generates embeddings for the query, which are dense numerical vectors representing the semantic meaning and context of the input text. These embeddings capture the query's semantics in a way that is conducive to further processing and analysis.

Along with embeddings, the machine learning model may extract additional features from the query, such as sentiment analysis, topic classification, or entity relationships. These features provide deeper insights into the query's characteristics and user intent.

At operation 412, the data platform identifies recommended tables and corresponding columns for each of the tables based on the application of the identified embeddings to the enriched database. Operation 412 involves applying these embeddings to the enriched database to understand the query's context and identify relevant tables and columns.

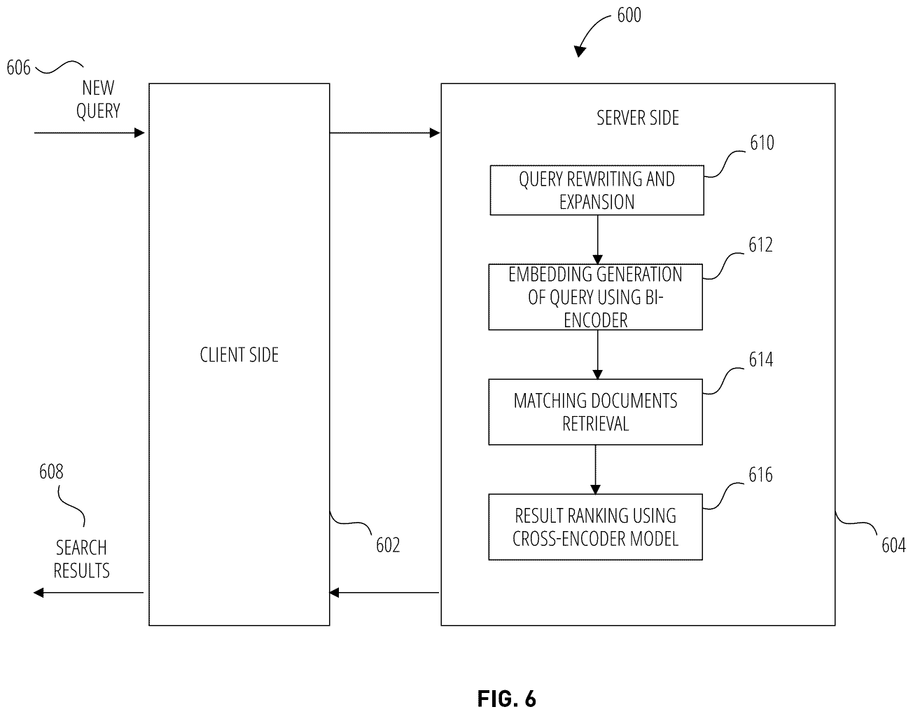

The embeddings from the query are compared against embeddings associated with tables, columns, and metadata in the enriched database (as will be further described in FIG. 6). This semantic matching process aims to find similarities and relevance between the query's semantics and database elements.

The data platform analyzes the embeddings from the query to determine the context and intent of the user's request. For example, if the query is about sales data, the platform understands that relevant tables might include “Sales,” “Transactions,” or “Revenue.” Based on semantic mapping techniques, the platform identifies tables in the enriched database that have similar semantic embeddings or are contextually relevant to the query. This mapping considers factors such as table names, aliases, descriptions, and historical usage patterns.

Once relevant tables are identified, the platform selects corresponding columns within these tables that are most likely to fulfill the query's requirements. The embeddings from the query are matched against embeddings associated with columns in the identified tables. Columns with embeddings that closely match the query's semantics or are historically associated with similar queries are prioritized.

A ranking algorithm is applied to the identified tables and columns to prioritize the most relevant ones. This algorithm considers various factors, such as embedding similarity such as how closely the embeddings of tables and columns match the query's embeddings, historical usage such as the frequency and relevance of tables and columns in fulfilling similar past queries, and metadata signals extracted during enrichment, such as popularity metrics, alias usage, and filtering patterns.

Each table and its corresponding columns receive a relevance score based on these factors. The platform ranks tables and columns based on these scores, with higher-ranked entities being recommended as more relevant to the query.

The recommended tables and corresponding columns are presented to the user through a user interface (UI) or application interface. This presentation may include descriptions, metadata, and contextually relevant information to assist the user in understanding why these entities are recommended. The UI may allow users to provide feedback on the recommendations, further refining the platform's understanding and improving future recommendations.

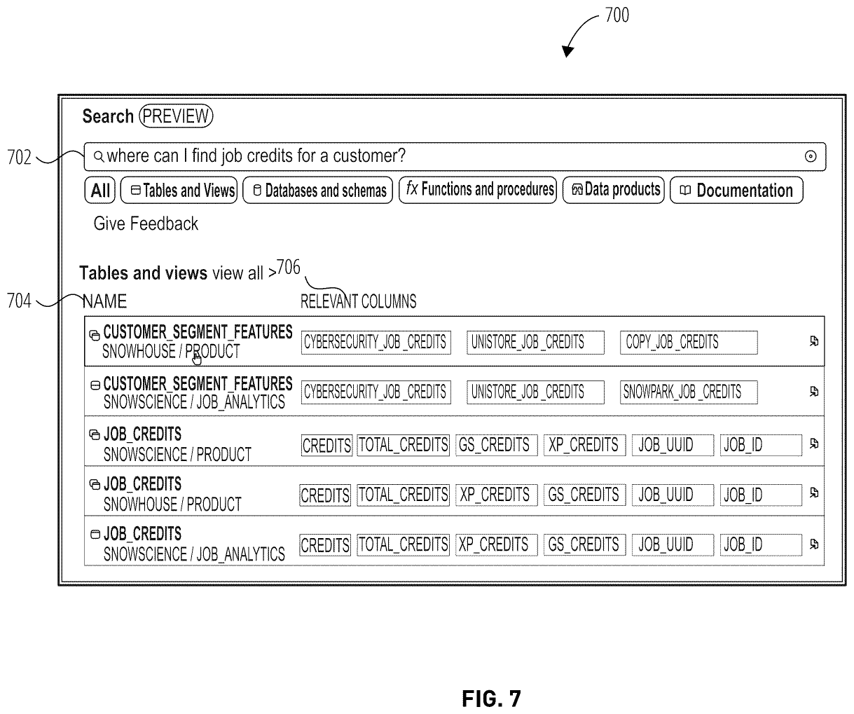

At operation 414, the data platform displays the recommended tables and corresponding columns for each of the tables to a user interface of a user device of the first user. The user device refers to the device (e.g., computer, smartphone, tablet) used by the first user to interact with the data platform and access query results. The user interface includes visual elements, such as screens, menus, buttons, and data displays, designed to present information and facilitate user interaction. FIG. 7 illustrates an example of a user interface displaying the recommended tables and corresponding columns in response to a natural language search query.

FIG. 6 illustrates an architectural diagram 600 illustrating the generation of embeddings to recommend tables and columns according to some examples. The client side includes the user's device that comprises a user's interface or application where the user inputs queries or interacts with the data platform. This can include a web browser, a mobile app, or any other interface used to access the data platform.

A new query 606 is entered by the user into the client side 602. This query 606 can be in natural language, meaning it is expressed in a way that is easy for humans to understand and communicate. The user formulates the query 606 based on their information needs or tasks. For example, the client may type “Show sales data for Q1 2023” or “Find customer reviews for product X.”

The client side 602 represents the query 606 in a format that can be transmitted to the server side 604 for processing. This representation can involve converting the query 606 into a structured format or encoding it in a way that preserves its semantic meaning.

The server side 604 includes the backend infrastructure of the data platform responsible for processing and handling user requests, including queries. Upon receiving the new query 606 from the client side 602, the server side 604 initiates the process of query handling and analysis. Along with the query text, the server side 604 may receive additional contextual information or metadata related to the query 606, such as user identifiers, session IDs, timestamp, and any relevant preferences or settings.

The server side infrastructure receives the incoming query request and begins processing it according to the system's query processing pipeline. The server side 604 performs query rewriting and expansion 610, which includes annotating queries or finding synonyms.

Query rewriting includes a process where the server side 604 modifies or enhances the original user query to improve understanding, accuracy, and relevance in retrieving results. This can involve several techniques such as annotating queries. Annotating queries can include adding contextual information, tags, or metadata to the query to provide additional context and enhance understanding. For example, if the original query is “Display monthly revenue trends,” the server may annotate it with metadata tags like “Time Range: Past Year,” “Data Type: Revenue,” and “Visualization: Trends.”

Synonym expansion can include identifying synonyms or related terms for words in the query to broaden the scope of search and improve retrieval accuracy. For example, for the query “Show customer reviews,” synonyms like “Display client feedback,” “Present consumer opinions,” or “View user ratings” may be identified and added to the query for expanded search coverage.

The data platform can perform query reformulation, which can involve restructuring or refining the query to improve its clarity, specificity, and alignment with available data sources. For example, if the original query is vague, such as “Analyze product data,” the server may reformulate it to “Perform detailed analysis on product sales, customer feedback, and market trends for the past six months.”

The data platform can perform semantic annotation. Semantic annotation can involve adding semantic labels or tags to the query components (keywords, entities) to aid in semantic understanding and processing. For example, annotating the query “Find sales data” with semantic tags like “Action: Find,” “Category: Sales,” and “Data Type: Data” helps the data platform understand the query's purpose and context.

The server side 604 can generate embeddings using a bi-encoder 612. Embeddings include numerical representations of words, phrases, or sentences in a high-dimensional vector space. These embeddings capture semantic relationships and contextual information, enabling machines to understand and process textual data effectively.

A bi-encoder includes a type of neural network architecture used for generating embeddings, which includes two separate encoders, one for input text (query, in this case) and another for context (table names, column names, metadata, etc.). The bi-encoder aims to encode both the query and context into embeddings that capture their semantic similarities.

The input query text is encoded using the query encoder component of the bi-encoder. This encoding converts the query into a dense vector representation in the embedding space, preserving semantic information and contextual meaning. Concurrently, the context (e.g., table names, column names, metadata) associated with the query is encoded using the context encoder component of the bi-encoder. Each element of the context is transformed into a corresponding dense vector representation in the embedding space.

The query-encoded vector and context-encoded vectors are processed together by the bi-encoder model. The model learns to generate embeddings that capture the semantic relationships between the query and context elements. The bi-encoder outputs embeddings that reflect the semantic similarity and relevance between the query and various context elements. Similar query-context pairs have embeddings that are closer together in the embedding space, while dissimilar pairs are farther apart.

The bi-encoder model is trained on a dataset of query-context pairs, where the model learns to generate embeddings that minimize the distance between similar pairs and maximize the distance between dissimilar pairs. In some cases, the bi-encoder model can process multiple query-context pairs simultaneously in batch mode, improving computational efficiency and scalability for large-scale applications.

In some examples, after query rewriting and expansion, the server side uses a bi-encoder model to generate embeddings for the modified query and relevant context elements (e.g., table names, column names). These embeddings capture semantic similarities and relationships between the query and context, forming dense vector representations in the embedding space.

In some cases, the data platform performs keyword retrieval and vector retrieval for matching documents retrieval 614. Keyword retrieval can include identifying key terms, entities, or concepts from the query and mapping them to relevant elements in the context (e.g., tables, columns, metadata). The server side 604 analyzes the query to extract important keywords, phrases, and entities that express the user's information needs. Extracted keywords are mapped to relevant components in the context, such as table names, column names, or metadata attributes, based on semantic relevance and contextual understanding.

In some cases, the data platform performs vector retrieval, which includes retrieving vectors (embeddings) from the embedding space that correspond to the query and context elements. The server side 604 retrieves the embeddings generated by the bi-encoder model for the query and context elements. The retrieved vectors are compared and matched to identify the most relevant query-context pairs based on vector similarity metrics (e.g., cosine similarity, Euclidean distance).

The data platform performs result ranking using a cross-encoder model 616 to rank the recommended tables and columns. The server side 604 employs a machine learning model, such as a cross-encoder model, to rank the recommended tables and columns based on their relevance to the user query. A cross-encoder model considers both the query and context together to generate rankings.

The cross-encoder model takes input pairs consisting of the query and each candidate context element (table or column). For example, (Query: “Display monthly revenue trends,” Context: “SalesData table”). The model encodes the input pair into a joint representation in a shared embedding space, capturing the semantic relationships between the query and context. The model computes a relevance score or ranking score for each input pair based on the learned representations and similarity metrics. Higher scores indicate greater relevance.

Candidate tables and columns are generated based on keyword retrieval and vector retrieval. These candidates are potential matches for fulfilling the user query. The server 604 side may expand the query or context further based on semantic analysis or domain-specific rules to enhance candidate generation. Each candidate context element (table or column) is paired with the user query to form input pairs for the cross-encoder model. The cross-encoder model encodes each input pair, representing the query and context relationship in the shared embedding space. This encoding captures semantic similarities and relevance.

For example, after keyword retrieval and vector retrieval, the server side generates candidate tables and columns relevant to the query “Display monthly revenue trends.” These candidates are paired with the query to form input pairs for the cross-encoder model. The model computes relevance scores for each pair, ranking the tables and columns based on their alignment with the query.

The server side generates a ranked list of recommended tables and corresponding columns based on the relevance scores computed by the machine learning model. For example, after the machine learning model ranks the recommended tables and columns based on relevance scores, the server side generates a ranked list such as:
1. Table: SalesData, Columns: Revenue, Date
2. Table: CustomerFeedback, Columns: Rating, Feedback
3. Table: MarketTrends, Columns: ProductCategory, SalesVolume

This ranked list is transmitted back to the client side 602, where it is processed and displayed to the user for review and selection 608.

In some cases, the query history is also processed by a bi-encoder model to generate historical query embeddings. In some cases, the bi-encoder model to generate the embeddings for the historical query data is the same as the bi-encoder model that generates the embeddings for the new query. In other cases, the bi-encoder model is different and trained separately.

The data platform gathers historical query data from the data platform's database or logs. The data platform utilizes the same bi-encoder model used for new search queries to generate embeddings for historical queries and their contexts. The bi-encoder model encodes each historical query-context pair using the bi-encoder model, producing dense vector representations (embeddings) in the shared embedding space. The model learns to capture semantic relationships and similarities between historical queries and their associated context elements, encapsulating past user intent and data relevance in the embeddings.

The data platform can then compare the historical query embeddings with the embeddings generated for the new search query using similarity metrics such as cosine similarity or Euclidean distance. By comparing embeddings, the data platform is comparing apples to apples, as both historical and new query embeddings exist in the same embedding space, capturing similar semantic properties.

The data platform applies a similarity threshold to determine whether historical query embeddings are sufficiently similar to the new query embeddings, indicating relevance or similarity in user intent and data context. Comparing historical query embeddings helps assess the contextual relevance of the new query by leveraging past user interactions and data associations.

By leveraging historical query embeddings and comparing them to new query embeddings, one can enhance semantic understanding, improve relevance, and provide personalized recommendations or search results, contributing to a more effective and user-centric information retrieval system.

FIG. 7 is a user interface 700 illustrating a natural language query and resulting table and column recommendations, according to some examples. The data platform generates a UI component that displays the recommended tables and columns to the user.

The data platform displays table names 704 of recommended tables that are relevant to the user's query, descriptions or metadata and additional information about each table, such as descriptions, aliases, metadata attributes (e.g., creation date, last modified), and contextual notes to help users understand the tables' purposes, icons or thumbnails including visual indicators (icons, thumbnails) that represent each table, making the UI more visually appealing and intuitive, and navigation options such as links or buttons that allow users to navigate to detailed views of each recommended table for further exploration. The data platform also displays column names 706 for each of the recommended tables in response to the natural language query 702.

Users may have options to filter or sort columns based on criteria such as popularity, data types, alphabetical order, or relevance to the query context. The UI 700 allows the user to interact with the displayed recommendations. This interaction can include clicking or tapping on table names 704 or column names 706 to view detailed information, selecting checkboxes or using toggle switches to choose specific tables or columns for further actions (e.g., data exploration, analysis, visualization), and providing feedback or rating on the relevance and usefulness of the recommendations, which may be used to refine future recommendations through machine learning algorithms.

For each recommended table, the UI component also displays corresponding columns that are relevant to the user's query. Information about each column may include names, data types, descriptions, usage frequency, and relevance scores based on their alignment with the query's intent.

The UI 700 may dynamically update recommendations based on user actions, such as refining the query, adding filters, or selecting different parameters. The UI 700 is designed to be responsive, adapting to different screen sizes and device orientations for optimal user experience.

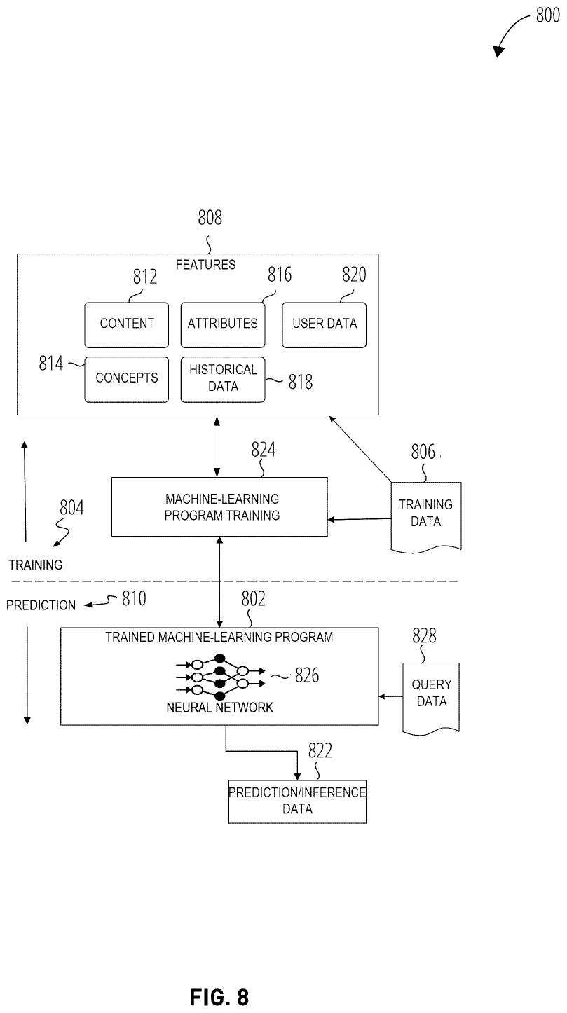

FIG. 8 illustrates further details of two example phases, namely a training phase 804 (e.g., part of the model selection and training 906) and a prediction phase 810 (part of prediction 910). Prior to the training phase 804, feature engineering 904 is used to identify features 808. This may include identifying informative, discriminating, and independent features for effectively operating the trained machine-learning program 802 in pattern recognition, classification, and regression. In some examples, the training data 806 includes labeled data, known for pre-identified features 808 and one or more outcomes. Each of the features 808 may be a variable or attribute, such as an individual measurable property of a process, article, system, or phenomenon represented by a data set (e.g., the training data 806). Features 808 may also be of different types, such as numeric features, strings, and graphs, and may include one or more of content 812, concepts 814, attributes 816, historical data 818, and/or user data 820, merely for example.

In training phase 804, the machine-learning pipeline 800 uses the training data 806 to find correlations among the features 808 that affect a predicted outcome or prediction/inference data 822.

With the training data 806 and the identified features 808, the trained machine-learning program 802 is trained during the training phase 804 during machine-learning program training 824. The machine-learning program training 824 appraises values of the features 808 as they correlate to the training data 806. The result of the training is the trained machine-learning program 802 (e.g., a trained or learned model).

Further, the training phase 804 may involve machine learning, in which the training data 806 is structured (e.g., labeled during preprocessing operations). The trained machine-learning program 802 implements a neural network 826 capable of performing, for example, classification and clustering operations. In other examples, the training phase 804 may involve deep learning, in which the training data 806 is unstructured, and the trained machine-learning program 802 implements a deep neural network 826 that can perform both 1 feature extraction and classification/clustering operations.

In some examples, a neural network 826 may be generated during the training phase 804 and implemented within the trained machine-learning program 802. The neural network 826 includes a hierarchical (e.g., layered) organization of neurons, with each layer consisting of multiple neurons or nodes. Neurons in the input layer receive the input data, while neurons in the output layer produce the final output of the network. Between the input and output layers, there may be one or more hidden layers, each consisting of multiple neurons.

Each neuron in the neural network 826 operationally computes a function, such as an activation function, which takes as input the weighted sum of the outputs of the neurons in the previous layer, as well as a bias term. The output of this function is then passed as input to the neurons in the next layer. If the output of the activation function exceeds a certain threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning algorithm to optimize the performance of the network. Different types of neural networks may use different activation functions and learning algorithms, affecting their performance on different tasks. The layered organization of neurons and the use of activation functions and weights enable neural networks to model complex relationships between inputs and outputs, and to generalize to new inputs that were not seen during training.

In some examples, the neural network 826 may also be one of several different types of neural networks, such as a single-layer feed-forward network, a Multilayer Perceptron (MLP), an Artificial Neural Network (ANN), a Recurrent Neural Network (RNN), a Long Short-Term Memory Network (LSTM), a Bidirectional Neural Network, a symmetrically connected neural network, a Deep Belief Network (DBN), a Convolutional Neural Network (CNN), a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

In addition to the training phase 804, a validation phase may be performed on a separate dataset known as the validation dataset. The validation dataset is used to tune the hyperparameters of a model, such as the learning rate and the regularization parameter. The hyperparameters are adjusted to improve the model's performance on the validation dataset.

Once a model is fully trained and validated, in a testing phase, the model may be tested on a new dataset. The testing dataset is used to evaluate the model's performance and ensure that the model has not overfitted the training data.

In prediction phase 810, the trained machine-learning program 802 uses the features 808 for analyzing query data 828 to generate inferences, outcomes, or predictions, as examples of a prediction/inference data 822. For example, during prediction phase 810, the trained machine-learning program 802 generates an output. Query data 828 is provided as an input to the trained machine-learning program 802, and the trained machine-learning program 802 generates the prediction/inference data 822 as output, responsive to receipt of the query data 828.

In some examples, the trained machine-learning program 802 may be a generative AI model. Generative AI is a term that may refer to any type of artificial intelligence that can create new content from training data 806. For example, generative AI can produce text, images, video, audio, code, or synthetic data similar to the original data but not identical.

Some of the techniques that may be used in generative AI are: Convolutional Neural Networks, Recurrent Neural Networks, generative adversarial networks, variational autoencoders, transformer models, and the like.

For example, Convolutional Neural Networks (CNNs) can be used for image recognition and computer vision tasks. CNNs may, for example, be designed to extract features from images by using filters or kernels that scan the input image and highlight important patterns. Recurrent Neural Networks (RNNs) can be used for processing sequential data, such as speech, text, and time series data, for example. RNNs employ feedback loops that allow them to capture temporal dependencies and remember past inputs. Generative adversarial networks (GANs) can include two neural networks: a generator and a discriminator. The generator network attempts to create realistic content that can “fool” the discriminator network, while the discriminator network attempts to distinguish between real and fake content. The generator and discriminator networks compete with each other and improve over time. Variational autoencoders (VAEs) can encode input data into a latent space (e.g., a compressed representation) and then decode it back into output data. The latent space can be manipulated to generate new variations of the output data. VAEs may use self-attention mechanisms to process input data, allowing them to handle long text sequences and capture complex dependencies. Transformer models can use attention mechanisms to learn the relationships between different parts of input data (such as words or pixels) and generate output data based on these relationships. Transformer models can handle sequential data, such as text or speech, as well as non-sequential data, such as images or code. In generative AI examples, the output prediction/inference data 822 can include predictions, translations, summaries, media content, and the like, or some combination thereof.

In some example embodiments, computer-readable files come in several varieties, including unstructured files, semi-structured files, and structured files. These terms may mean different things to different people. Examples of structured files include Variant Call Format (VCF) files, Keithley Data File (KDF) files, Hierarchical Data Format version 5 (HDF5) files, and the like. As known to those of skill in the relevant arts, VCF files are often used in the bioinformatics field for storing, e.g., gene-sequence variations, KDF files are often used in the semiconductor industry for storing, e.g., semiconductor-testing data, and HDF5 files are often used in industries such as the aeronautics industry, in that case for storing data such as aircraft-emissions data.

As used herein, examples of unstructured files include image files, video files, PDFs, audio files, and the like; examples of semi-structured files include JavaScript Object Notation (JSON) files, eXtensible Markup Language (XML) files, and the like. Numerous other example unstructured-file types, semi-structured-file types, and structured-file types, as well as example uses thereof, could certainly be listed here as well and will be familiar to those of skill in the relevant arts. Different people of skill in the relevant arts may classify types of files differently among these categories and may use one or more different categories instead of or in addition to one or more of these.

Data platforms are widely used for data storage and data access in computing and communication contexts. Concerning architecture, a data platform could be an on-premises data platform, a network-based data platform (e.g., a cloud-based data platform), a combination of the two, and/or include another type of architecture. Concerning the type of data processing, a data platform could implement online analytical processing (OLAP), online transactional processing (OLTP), a combination of the two, and/or another type of data processing. Moreover, a data platform could be or include a relational database management system (RDBMS) and/or one or more other types of database management systems.

In a typical implementation, a cloud data platform 102 can include one or more databases that are respectively maintained in association with any number of customer accounts (e.g., accounts of one or more data providers), as well as one or more databases associated with a system account (e.g., an administrative account) of the data platform, one or more other databases used for administrative purposes, and/or one or more other databases that are maintained in association with one or more other organizations and/or for any other purposes. A cloud data platform 102 may also store metadata (e.g., account object metadata) in association with the data platform in general and in association with, for example, particular databases and/or particular customer accounts as well. Users and/or executing processes that are associated with a given customer account may, via one or more types of clients, be able to cause data to be ingested into the database, and may also be able to manipulate the data, add additional data, remove data, run queries against the data, generate views of the data, and so forth. As used herein, the terms “account object metadata” and “account object” are used interchangeably.

In an implementation of a cloud data platform 102, a given database (e.g., a database maintained for a customer account) may reside as an object within, e.g., a customer account, which may also include one or more other objects (e.g., users, roles, grants, shares, warehouses, resource monitors, integrations, network policies, and/or the like). Furthermore, a given object such as a database may itself contain one or more objects such as schemas, tables, materialized views, and/or the like. A given table may be organized as a collection of records (e.g., rows) so that each includes a plurality of attributes (e.g., columns). In some implementations, database data is physically stored across multiple storage units, which may be referred to as files, blocks, partitions, micro-partitions, and/or by one or more other names. In many cases, a database on a data platform serves as a backend for one or more applications that are executing on one or more application servers.

In the present disclosure, physical units of data that are stored in a cloud data platform—and that make up the content of, e.g., database tables in customer accounts (e.g., customer users)—are referred to as micro-partitions. In different implementations, a cloud data platform can store metadata in micro-partitions as well. The term “micro-partitions” is distinguished in this disclosure from the term “files,” which, as used herein, refers to data units such as image files (e.g., Joint Photographic Experts Group (JPEG) files, Portable Network Graphics (PNG) files, etc.), video files (e.g., Moving Picture Experts Group (MPEG) files, MPEG-4 (MP4) files, Advanced Video Coding High Definition (AVCHD) files, etc.), Portable Document Format (PDF) files, documents that are formatted to be compatible with one or more word-processing applications, documents that are formatted to be compatible with one or more spreadsheet applications, and/or the like. If stored internal to the cloud data platform, a given file is referred to herein as an “internal file” and may be stored in (or at, or on, etc.) what is referred to herein as an “internal storage location.” If stored external to the cloud data platform, a given file is referred to herein as an “external file” and is referred to as being stored in (or at, or on, etc.) what is referred to herein as an “external storage location.”

While example embodiments of the present disclosure reference commands in the standardized syntax of the programming language Structured Query Language (SQL), it will be understood by one having ordinary skill in the art that the present disclosure can similarly apply to other programming languages associated with communicating and retrieving data from a database.

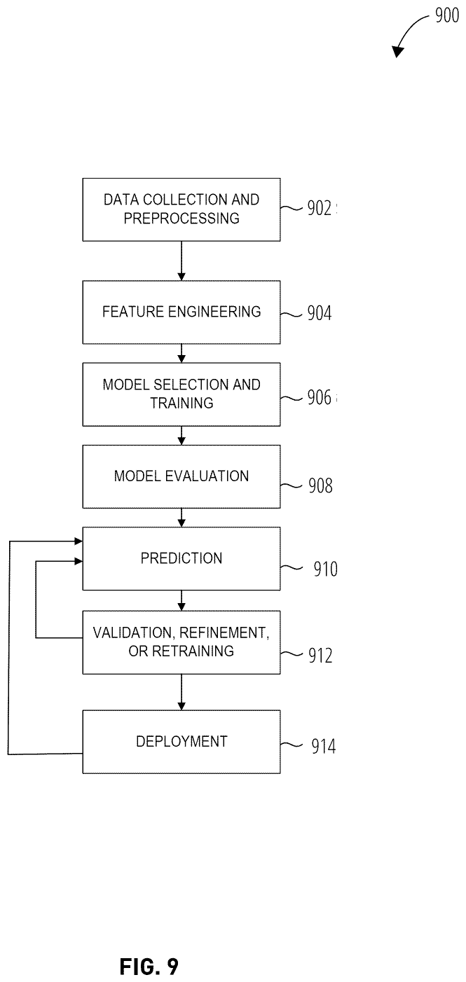

FIG. 9 depicts a machine-learning pipeline 900 and FIG. 9 illustrates training and use of a machine-learning program (e.g., model) 800. Specifically, FIG. 9 is a flowchart depicting a machine-learning pipeline 900, according to some examples. The machine-learning pipeline 900 can be used to generate a trained model, for example the trained machine-learning program 802 of FIG. 8, to perform operations associated with searches and query responses.

Broadly, machine learning may involve using computer algorithms to automatically learn patterns and relationships in data, potentially without the need for explicit programming. Machine learning algorithms can be divided into three main categories: supervised learning, unsupervised learning, self-supervised, and reinforcement learning.

For example, supervised learning involves training a model using labeled data to predict an output for new, unseen inputs. Examples of supervised learning algorithms include neural linear regression, decision trees, and networks. Unsupervised learning involves training a model on unlabeled data to find hidden patterns and relationships in the data. Examples of unsupervised learning algorithms include clustering, principal component analysis, and generative models like autoencoders. Reinforcement learning involves training a model to make decisions in a dynamic environment by receiving feedback in the form of rewards or penalties. Examples of reinforcement learning algorithms include Q-learning and policy gradient methods.

Examples of specific machine learning algorithms that may be deployed, according to some examples, include logistic regression, which is a type of supervised learning algorithm used for binary classification tasks. Logistic regression models the probability of a binary response variable based on one or more predictor variables. Another example type of machine learning algorithm is Naïve Bayes, which is another supervised learning algorithm used for classification tasks. Naïve Bayes is based on Bayes' theorem and assumes that the predictor variables are independent of each other. Random Forest is another type of supervised learning algorithm used for classification, regression, and other tasks. Random Forest builds a collection of decision trees and combines their outputs to make predictions.

Further examples include neural networks, which consist of interconnected layers of nodes (or neurons) that process information and make predictions based on the input data. Matrix factorization is another type of machine learning algorithm used for recommender systems and other tasks. Matrix factorization decomposes a matrix into two or more matrices to uncover hidden patterns or relationships in the data. Support Vector Machines (SVM) are a type of supervised learning algorithm used for classification, regression, and other tasks. SVM finds a hyperplane that separates the different classes in the data. Other types of machine learning algorithms include decision trees, k-nearest neighbors, clustering algorithms, and deep learning algorithms such as convolutional neural networks (CNN), recurrent neural networks (RNN), and transformer models. The choice of algorithm depends on the nature of the data, the complexity of the problem, and the performance requirements of the application.

The performance of machine learning models is typically evaluated on a separate test set of data that was not used during training to ensure that the model can generalize to new, unseen data.

Although several specific examples of machine learning algorithms are discussed herein, the principles discussed herein can be applied to other machine learning algorithms as well. Deep learning algorithms such as convolutional neural networks, recurrent neural networks, and transformers, as well as more traditional machine learning algorithms like decision trees, random forests, and gradient boosting may be used in various machine learning applications.

Two example types of problems in machine learning are classification problems and regression problems. Classification problems, also referred to as categorization problems, aim at classifying items into one of several category values (e.g., is this object an apple or an orange?). Regression algorithms aim at quantifying some items (for example, by providing a value that is a real number).

Turning to the training phases 804 as described and depicted in connection with FIG. 9, generating a trained machine-learning program 802 may include multiple phases that form part of the machine-learning pipeline 900, including for example the following phases illustrated in FIG. 9: data collection and preprocessing 902, feature engineering 904, model selection and training 906, model evaluation 908, prediction 910, validation, refinement, or retraining 912, and deployment 914, or a combination thereof.

For example, data collection and preprocessing 902 can include a phase for acquiring and cleaning data to ensure that it is suitable for use in the machine learning model. This phase may also include removing duplicates, handling missing values, and converting data into a suitable format. Feature engineering 904 can include a phase for selecting and transforming the training data 806 to create features that are useful for predicting the target variable. Feature engineering may include (1) receiving features 808 (e.g., as structured or labeled data in supervised learning) and/or (2) identifying features 808 (e.g., unstructured, or unlabeled data for unsupervised learning) in training data 806. Model selection and training 906 can include a phase for selecting an appropriate machine learning algorithm and training it on the preprocessed data. This phase may further involve splitting the data into training and testing sets, using cross-validation to evaluate the model, and tuning hyperparameters to improve performance.

In additional examples, model evaluation 908 can include a phase for evaluating the performance of a trained model (e.g., the trained machine-learning program 802) on a separate testing dataset. This phase can help determine if the model is overfitting or underfitting and determine whether the model is suitable for deployment. Prediction 910 can include a phase for using a trained model (e.g., trained machine-learning program 802) to generate predictions on new, unseen data. Validation, refinement or retraining 912 can include a phase for updating a model based on feedback generated from the prediction phase, such as new data or user feedback. Deployment 914 can include a phase for integrating the trained model (e.g., the trained machine-learning program 802) into a more extensive system or application, such as a web service, mobile app, or IoT device. This phase can involve setting up APIs, building a user interface, and ensuring that the model is scalable and can handle large volumes of data.

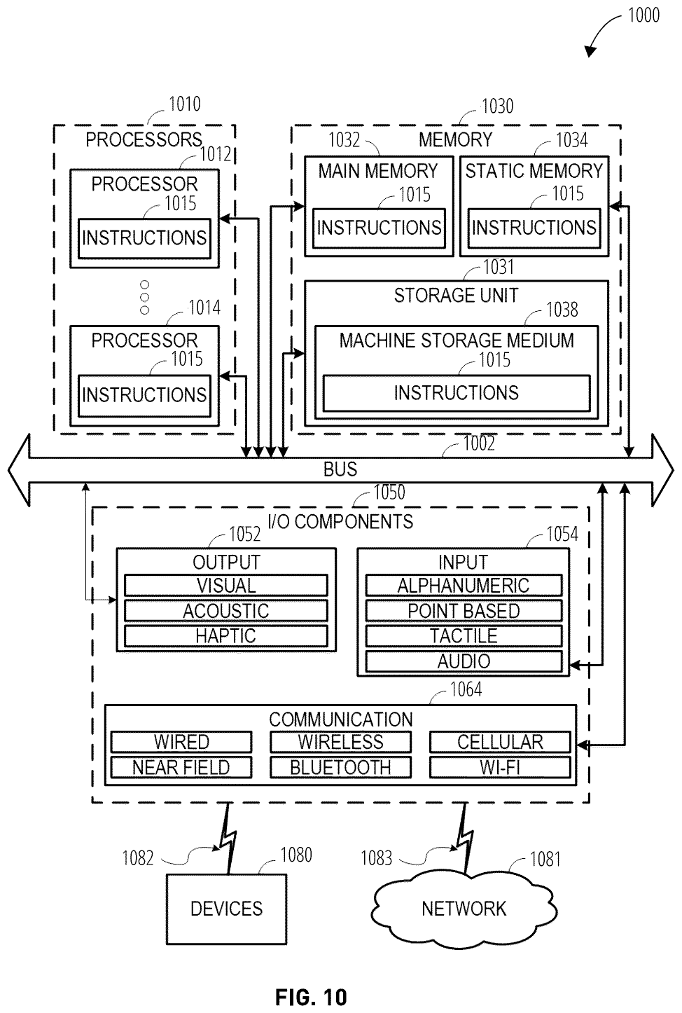

FIG. 10 illustrates a diagrammatic representation of a machine 1000 in the form of a computer system within which a set of instructions may be executed for causing the machine 1000 to perform any one or more of the methodologies discussed herein, according to an example embodiment. Specifically, FIG. 10 shows a diagrammatic representation of the machine 1000 in the example form of a computer system, within which instructions 1015 (e.g., software, a program, an application, an applet, an app, or other executable code), for causing the machine 1000 to perform any one or more of the methodologies discussed herein, may be executed. For example, the instructions 1015 may cause the machine 1000 to implement portions of the data flows described herein (e.g., data flows described and depicted in FIG. 10). In this way, the instructions 1015 transform a general, non-programmed machine into a particular machine 1000 (e.g., the client device 114 of FIG. 1, the compute service manager 108 of FIG. 1, the execution platform 110 of FIG. 1) that is specially configured to carry out any one of the described and illustrated functions in the manner described herein.

In alternative embodiments, the machine 1000 operates as a standalone device or may be coupled (e.g., networked) to other machines. In a networked deployment, the machine 1000 may operate in the capacity of a server machine or a client machine in a server-client network environment, or as a peer machine in a peer-to-peer (or distributed) network environment. The machine 1000 may comprise, but not be limited to, a server computer, a client computer, a personal computer (PC), a tablet computer, a laptop computer, a netbook, a smart phone, a mobile device, a network router, a network switch, a network bridge, or any machine capable of executing the instructions 1015, sequentially or otherwise, that specify actions to be taken by the machine 1000. Further, while only a single machine 1000 is illustrated, the term “machine” shall also be taken to include a collection of machines 1000 that individually or jointly execute the instructions 1015 to perform any one or more of the methodologies discussed herein.

The machine 1000 includes processors 1010 (such as processor 1012 and processor 1014), memory 1030, and input/output (I/O) I/O components 1050 (including output components 1052 and input components 1054) configured to communicate with each other such as via a bus 1002. In an example embodiment, the processors 1010 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 1012 and a processor 1014 that may execute the instructions 1015. The term “processor” is intended to include multi-core processors 1010 that may comprise two or more independent processors (sometimes referred to as “cores”) that may execute instructions 1015 contemporaneously. Although FIG. 10 shows multiple processors 1010, the machine 1000 may include a single processor with a single core, a single processor with multiple cores (e.g., a multi-core processor), multiple processors with a single core, multiple processors with multiple cores, or any combination thereof.

The memory 1030 may include a main memory 1032, a static memory 1034, and a storage unit 1031, all accessible to the processors 1010 such as via the bus 1002. The main memory 1032, the static memory 1034, and the storage unit 1031 comprise a machine storage medium 1038 that may store the instructions 1015 embodying any one or more of the methodologies or functions described herein. The instructions 1015 may also reside, completely or partially, within the main memory 1032, within the static memory 1034, within the storage unit 1031, within at least one of the processors 1010 (e.g., within the processor's cache memory), or any suitable combination thereof, during execution thereof by the machine 1000.

The I/O components 1050 include components to receive input, provide output, produce output, transmit information, exchange information, capture measurements, and so on. The specific I/O components 1050 that are included in a particular machine 1000 will depend on the type of machine. For example, portable machines, such as mobile phones, will likely include a touch input device or other such input mechanisms, while a headless server machine will likely not include such a touch input device. It will be appreciated that the I/O components 1050 may include many other components that are not shown in FIG. 10. The I/O components 1050 are grouped according to functionality merely for simplifying the following discussion and the grouping is in no way limiting. In various example embodiments, the I/O components 1050 may include output components 1052 and input components 1054. The output components 1052 may include visual components (e.g., a display such as a plasma display panel (PDP), a light emitting diode (LED) display, a liquid crystal display (LCD), a projector, or a cathode ray tube (CRT)), acoustic components (e.g., speakers), other signal generators, and so forth. The input components 1054 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

Communication may be implemented using a wide variety of technologies. The I/O components 1050 may include communication components 1064 operable to couple the machine 1000 to a network 1081 via a coupler 1083 or to devices 1080 via a coupling 1082. For example, the communication components 1064 may include a network interface component or another suitable device to interface with the network 1081. In further examples, the communication components 1064 may include wired communication components, wireless communication components, cellular communication components, and other communication components to provide communication via other modalities. The devices 1080 may be another machine or any of a wide variety of peripheral devices (e.g., a peripheral device coupled via a universal serial bus (USB)). For example, as noted above, the machine 1000 may correspond to any one of the client device 114, the compute service manager 108, and the execution platform 110, and may include any other of these systems and devices.

The various memories (e.g., 1030, 1032, 1034, and/or memory of the processor(s) 1010 and/or the storage unit 1031) may store one or more sets of instructions 1015 and data structures (e.g., software), embodying or utilized by any one or more of the methodologies or functions described herein. These instructions 1015, when executed by the processor(s) 1010, cause various operations to implement the disclosed embodiments.

Another general aspect is for a system that includes a memory comprising instructions and one or more computer processors or one or more hardware processors. The instructions, when executed by the one or more computer processors, cause the one or more computer processors to perform operations. In yet another general aspect, a tangible machine-readable storage medium (e.g., a non-transitory storage medium) includes instructions that, when executed by a machine, cause the machine to perform operations.

As used herein, the terms “machine-storage medium,” “device-storage medium,” and “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, (e.g., erasable programmable read-only memory (EPROM), electrically erasable programmable read-only memory (EEPROM), field-programmable gate arrays (FPGAs), and flash memory devices); magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 1081 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 1081 or a portion of the network 1081 may include a wireless or cellular network, and the coupling 1082 may be a Code Division Multiple Access (CDMA) connection, a Global System for Mobile communications (GSM) connection, or another type of cellular or wireless coupling. In this example, the coupling 1082 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 1015 may be transmitted or received over the network 1081 using a transmission medium via a network interface device (e.g., a network interface component included in the communication components 1064) and utilizing any one of a number of well-known transfer protocols (e.g., hypertext transfer protocol (HTTP)). Similarly, the instructions 1015 may be transmitted or received using a transmission medium via the coupling 1082 (e.g., a peer-to-peer coupling) to the devices 1080. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 1015 for execution by the machine 1000, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

The various operations of example methods described herein may be performed, at least partially, by one or more processors that are temporarily configured (e.g., by software) or permanently configured to perform the relevant operations. Similarly, the methods described herein may be at least partially processor implemented. For example, at least some of the operations of the methods described herein may be performed by one or more processors. The performance of certain of the operations may be distributed among the one or more processors, not only residing within a single machine, but also deployed across a number of machines. In some example embodiments, the processor or processors may be located in a single location (e.g., within a home environment, an office environment, or a server farm), while in other embodiments the processors may be distributed across a number of locations.

Although the embodiments of the present disclosure have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art, upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

Also, in the above Detailed Description, various features can be grouped together to streamline the disclosure. However, the claims cannot set forth every feature disclosed herein, as embodiments can feature a subset of said features. Further, embodiments can include fewer features than those disclosed in a particular example. Thus, the following claims are hereby incorporated into the Detailed Description, with each claim standing on its own as a separate embodiment. The scope of the embodiments disclosed herein is to be determined with reference to the appended claims, along with the full scope of equivalents to which such claims are entitled.

What is claimed is:

1. A computer system comprising:
at least one hardware processor; and
one or more computer storage media containing instructions that, when executed by the at least one hardware processor, cause the computer system to perform operations comprising:
accessing query history of a first user;
processing the query history of the first user using a first machine learning model to identify naming characteristics of the query history specific for the first user, the first machine learning model being trained to identify naming characteristics of query histories;
enriching a database comprising data associated with the first user with the identified naming characteristics of the query history;
receiving a new search query in natural language from the first user;
processing the new search query in the natural language using a second machine learning model to identify embeddings within the new search query;
identifying one or more recommended tables and corresponding columns for each of the recommended tables based on an application of the identified embeddings to the enriched database; and
causing display of the recommended tables and corresponding columns for each of the recommended tables by a user device of the first user.

2. The system of claim 1, wherein the naming characteristics include a frequency characteristic of a search term indicative of a frequency of a table or column used in the query history.

3. The system of claim 1, wherein the naming characteristics include an alias characteristic of a search term indicative of variations of naming conventions for a particular table name or column name.

4. The system of claim 1, wherein the naming characteristics include a table join characteristic of a search term indicative of a plurality of tables joined in order to respond to a query in the query history.

5. The system of claim 1, wherein the naming characteristics include column properties used for assessment in order to respond to a query in the query history, the column properties including a group by characteristic, a measure characteristic, and a filtering characteristic.

6. The system of claim 1, wherein the naming characteristics include subquery aliases that are used to identify and label subqueries within a larger overall query.

7. The system of claim 1, wherein the naming characteristics include where clauses and expressions that include frequently used filters, conditions, and data selection criteria in the query history.

8. The system of claim 1, wherein enriching the database comprises:
identifying naming characteristics specific to table naming conventions;
aggregating the naming characteristics specific to the table naming conventions;
identifying naming characteristics specific to column naming conventions;
aggregating the naming characteristics specific to the column naming conventions; and
indexing the aggregated naming characteristics specific to the table naming conventions with the aggregated naming characteristics specific to the column naming conventions.

9. The system of claim 1, wherein the query history includes SQL queries of the first user.

10. The system of claim 1, wherein the query history includes natural language prompts of the first user for querying data stored in the database.

11. The system of claim 1, wherein the second machine learning model include a large language model (LLM) to perform semantic analysis on the new search query.

12. The system of claim 11, wherein the second machine learning model further includes a bi-encoder model, wherein an output of the LLM is inputted into the bi-encoder model to generate the embeddings.

13. The system of claim 12, wherein the bi-encoder model is trained to convert the new search query into a dense vector representation in an embedding space to generate the embeddings.

14. The system of claim 1, wherein the second machine learning model include a bi-encoder model trained to generate embeddings from new search queries.

15. The system of claim 14, wherein identifying the recommended tables and corresponding columns includes inputting an output of the bi-encoder model into a cross-encoder model to generate rankings for the tables and corresponding columns.

16. The system of claim 14, wherein the first machine learning model includes the bi-encoder model to generate historical embeddings from the query history, the recommended tables and corresponding columns being based on both an output of the bi-encoder model using the query history and the bi-encoder model using the new search query.

17. A method performed by at least one hardware processor, the method comprising:
accessing query history of a first user;
processing the query history of the first user using a first machine learning model to identify naming characteristics of the query history specific for the first user, the first machine learning model being trained to identify naming characteristics of query histories;
enriching a database comprising data associated with the first user with the identified naming characteristics of the query history;
receiving a new search query in natural language from the first user;
processing the new search query in the natural language using a second machine learning model to identify embeddings within the new search query;
identifying one or more recommended tables and corresponding columns for each of the recommended tables based on an application of the identified embeddings to the enriched database; and
causing display of the recommended tables and corresponding columns for each of the recommended tables by a user device of the first user.

18. The method of claim 17, wherein the naming characteristics include a frequency characteristic of a search term indicative of a frequency of a table or column used in the query history.

19. The method of claim 17, wherein the naming characteristics include an alias characteristic of a search term indicative of variations of naming conventions for a particular table name or column name.

20. The method of claim 17, wherein the naming characteristics include a table join characteristic of a search term indicative of a plurality of tables joined in order to respond to a query in the query history.

21. The method of claim 17, wherein the naming characteristics include column properties used for assessment in order to respond to a query in the query history, the column properties including a group by characteristic, a measure characteristic, and a filtering characteristic.

22. The method of claim 17, wherein the naming characteristics include subquery aliases that are used to identify and label subqueries within a larger overall query.

23. The method of claim 17, wherein the naming characteristics include where clauses and expressions that include frequently used filters, conditions, and data selection criteria in the query history.

24. The method of claim 17, wherein enriching the database comprises:
identifying naming characteristics specific to table naming conventions;
aggregating the naming characteristics specific to the table naming conventions;
identifying naming characteristics specific to column naming conventions;
aggregating the naming characteristics specific to the column naming conventions; and
indexing the aggregated naming characteristics specific to the table naming conventions with the aggregated naming characteristics specific to the column naming conventions.

25. One or more machine-storage media containing instructions that, when executed by at least one hardware processor of a computer system, cause the computer system to perform operations comprising:
accessing query history of a first user;
processing the query history of the first user using a first machine learning model to identify naming characteristics of the query history specific for the first user, the first machine learning model being trained to identify naming characteristics of query histories;
enriching a database comprising data associated with the first user with the identified naming characteristics of the query history;
receiving a new search query in natural language from the first user;
processing the new search query in the natural language using a second machine learning model to identify embeddings within the new search query;
identifying one or more recommended tables and corresponding columns for each of the recommended tables based on an application of the identified embeddings to the enriched database; and
causing display of the recommended tables and corresponding columns for each of the recommended tables by a user device of the first user.
